(19) United States
(12) Patent Application Publication
(10) Pub. No.: US 2026/0205186 A1
(43) Pub. Date: Jul. 16, 2026

(54) PARAMETER REPORTING FOR MULTIPLE SUBBANDS

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Chenxi HAO, Beijing (CN); Yu ZHANG, San Diego, CA (US); Ahmed Attia ABOTABL, San Diego, CA (US)

(21) Appl. No.: 19/136,240

(22) PCT Filed: Jan. 25, 2023
(86) PCT No.: PCT/CN2023/073466

§ 371 Date: Jun. 5, 2025

(51) Int. Cl. H04B 7/06

(52) U.S. Cl. CPC H04B 7/0639

(57) ABSTRACT

Methods, systems, and devices for wireless communication are described. A user equipment (UE) may receive a control message that indicates a set of parameters for reporting a compressed representation of coefficients for a precoding matrix. The coefficients may correspond to multiple downlink subbands associated with subband full-duplex (SBFD) operations. The UE may generate a report that indicates the compressed representation of the coefficients. The report may be generated in accordance with the set of parameters and a mapping rule. The mapping rule may be based on a quantity of parts included in the report. The UE may transmit the report.

### CROSS REFERENCE

The present application is a 371 national phase filing of International PCT Application No. PCT/CN2023/073466 by IBRAHIM et al., entitled “PARAMETER REPORTING FOR MULTIPLE SUBBANDS,” filed Jan. 25, 2023, which is assigned to the assignee hereof, and which is expressly incorporated by reference in its entirety herein.

### FIELD OF TECHNOLOGY

The following relates to wireless communication, including parameter reporting for multiple subbands.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Some communications systems may support subband full-duplex (SBFD) operations.

### SUMMARY

The described techniques relate to improved methods, systems, devices, and apparatuses that enable parameter reporting for multiple subbands. For example, the described techniques provide a framework for reporting precoding matrix coefficients for multiple subbands in a single report. In some examples, a user equipment (UE) may receive a control message that indicates a set of parameters for reporting a compressed representation of coefficients for a precoding matrix. The coefficients may correspond to multiple downlink subbands associated with subband full-duplex (SBFD) operations. After receiving the control message, the UE may generate a report that indicates the compressed representation of the coefficients. For instance, the report may be generated in accordance with the set of parameters and a mapping rule. The mapping rule may, in some examples, be based on a quantity of parts included or to be included in the report, and the UE may transmit the report to a network entity.

A method for wireless communication at a UE is described. The method may include receiving a control message that indicates a set of parameters for reporting a compressed representation of a set of multiple coefficients for a precoding matrix, the set of multiple coefficients corresponding to a set of multiple downlink subbands associated with SBFD operations, generating a report that indicates the compressed representation of the set of multiple coefficients, where the report is generated in accordance with the set of parameters and a mapping rule that is based on a quantity of parts included in the report, and transmitting the report based on the generation.

An apparatus for wireless communication is described. The apparatus may include a processor, memory in electronic communication with the processor, and instructions stored in the memory. The instructions may be executable by the processor to receive a control message that indicates a set of parameters for reporting a compressed representation of a set of multiple coefficients for a precoding matrix, the set of multiple coefficients corresponding to a set of multiple downlink subbands associated with SBFD operations, generate a report that indicates the compressed representation of the set of multiple coefficients, where the report is generated in accordance with the set of parameters and a mapping rule that is based on a quantity of parts included in the report, and transmit the report based on the generation.

Another apparatus for wireless communication is described. The apparatus may include means for receiving a control message that indicates a set of parameters for reporting a compressed representation of a set of multiple coefficients for a precoding matrix, the set of multiple coefficients corresponding to a set of multiple downlink subbands associated with SBFD operations, means for generating a report that indicates the compressed representation of the set of multiple coefficients, where the report is generated in accordance with the set of parameters and a mapping rule that is based on a quantity of parts included in the report, and means for transmitting the report based on the generation.

A non-transitory computer-readable medium storing code for wireless communication at a UE is described. The code may include instructions executable to receive a control message that indicates a set of parameters for reporting a compressed representation of a set of multiple coefficients for a precoding matrix, the set of multiple coefficients corresponding to a set of multiple downlink subbands associated with SBFD operations, generate a report that indicates the compressed representation of the set of multiple coefficients, where the report is generated in accordance with the set of parameters and a mapping rule that is based on a quantity of parts included in the report, and transmit the report based on the generation.

In some examples of the method, apparatuses, and non-transitory computer-readable medium described herein, generating the report may include operations, features, means, or instructions for generating a first part of the report that indicates a quantity of coefficients included in the set of multiple coefficients and generating at least a second part of the report that indicates one or more mappings for the set of multiple coefficients, where the one or more mappings may be based on the mapping rule, and where the first part and at least the second part indicate the compressed representation of the set of multiple coefficients.

In some examples of the method, apparatuses, and non-transitory computer-readable medium described herein, generating at least the second part of the report may include operations, features, means, or instructions for generating the second part that indicates a first mapping for a first portion of the set of multiple coefficients and a second mapping for a second portion of the set of multiple coefficients, where the first portion corresponds to a first downlink subband of the set of multiple downlink subbands, and where the second portion corresponds to a second downlink subband of the set of multiple downlink subbands.

In some examples of the method, apparatuses, and non-transitory computer-readable medium described herein, generating at least the second part of the report may include operations, features, means, or instructions for generating the second part that indicates a mapping for the set of multiple coefficients, where the mapping may be based on the mapping rule.

In some examples of the method, apparatuses, and non-transitory computer-readable medium described herein, generating at least the second part of the report may include operations, features, means, or instructions for generating the second part that indicates a first mapping for a first portion of the set of multiple coefficients, the first portion corresponding to a first downlink subband of the set of multiple downlink subbands and generating a third part that indicates a second mapping for a second portion of the set of multiple coefficients, the second portion corresponding to a second downlink subband of the set of multiple downlink subbands.

In some examples of the method, apparatuses, and non-transitory computer-readable medium described herein, the second part further indicates a spatial domain basis set associated with the first downlink subband and the second downlink subband.

In some examples of the method, apparatuses, and non-transitory computer-readable medium described herein, the set of parameters includes a same set of parameters for each subband of the set of multiple downlink subbands.

In some examples of the method, apparatuses, and non-transitory computer-readable medium described herein, the set of parameters includes a respective subset of parameters for each subband of the set of multiple downlink subbands.

In some examples of the method, apparatuses, and non-transitory computer-readable medium described herein, the report includes a field that indicates a quantity of coefficients included in the set of multiple coefficients and the field may be based on a quantity of reporting subbands associated with the set of multiple downlink subbands or the set of parameters, or both.

In some examples of the method, apparatuses, and non-transitory computer-readable medium described herein, each downlink subband of the set of multiple downlink subbands may be associated with a same quantity of reporting subbands or a same set of parameters, or both and the field indicates a same quantity of coefficients for each downlink subband of the set of multiple downlink subbands.

In some examples of the method, apparatuses, and non-transitory computer-readable medium described herein, each downlink subband of the set of multiple downlink subbands may be associated with a respective quantity of reporting subbands or a respective set of parameters, or both and the field indicates a first portion of the quantity of coefficients that corresponds to a first downlink subband of the set of multiple downlink subbands and indicates a second portion of the quantity of coefficients that corresponds to a second downlink subband of the set of multiple downlink subbands.

Some examples of the method, apparatuses, and non-transitory computer-readable medium described herein may further include operations, features, means, or instructions for aligning a first portion of the set of multiple coefficients that corresponds to a first downlink subband of the set of multiple downlink subbands in accordance with a first coefficient included in the first portion and aligning a second portion of the set of multiple coefficients that correspond to a second downlink subband in accordance with the first coefficient or a second coefficient included in the second portion, where the compressed representation of the set of multiple coefficients may be based on the alignment of the first portion and the second portion.

Some examples of the method, apparatuses, and non-transitory computer-readable medium described herein may further include operations, features, means, or instructions for determining that a quantity of reporting subbands associated with the set of multiple downlink subbands satisfies a threshold and selecting a first set of coefficients from the first portion and a second set of coefficients from the second portion based on the determination, where the compressed representation of the set of multiple coefficients may be based on the first set of coefficients and the second set of coefficients.

In some examples of the method, apparatuses, and non-transitory computer-readable medium described herein, the first set of coefficients and the second set of coefficients may be selected in accordance with a same selection window.

In some examples of the method, apparatuses, and non-transitory computer-readable medium described herein, the first set of coefficients may be selected in accordance with a first selection window associated with the first downlink subband and the second set of coefficients may be selected in accordance with a second selection window associated with the second downlink subband, the first selection window being different from the second selection window.

A method for wireless communication at a network entity is described. The method may include outputting a control message that indicates a set of parameters for reporting a compressed representation of a set of multiple coefficients for a precoding matrix, the set of multiple coefficients corresponding to a set of multiple downlink subbands associated with SBFD operations and obtaining a report that indicates the compressed representation of the set of multiple coefficients in response to outputting the control message, where the report is generated in accordance with the set of parameters and a mapping rule that is based on a quantity of parts included in the report.

An apparatus for wireless communication is described. The apparatus may include a processor, memory in electronic communication with the processor, and instructions stored in the memory. The instructions may be executable by the processor to output a control message that indicates a set of parameters for reporting a compressed representation of a set of multiple coefficients for a precoding matrix, the set of multiple coefficients corresponding to a set of multiple downlink subbands associated with SBFD operations and obtain a report that indicates the compressed representation of the set of multiple coefficients in response to outputting the control message, where the report is generated in accordance with the set of parameters and a mapping rule that is based on a quantity of parts included in the report.

Another apparatus for wireless communication is described. The apparatus may include means for outputting a control message that indicates a set of parameters for reporting a compressed representation of a set of multiple coefficients for a precoding matrix, the set of multiple coefficients corresponding to a set of multiple downlink subbands associated with SBFD operations and means for obtaining a report that indicates the compressed representation of the set of multiple coefficients in response to outputting the control message, where the report is generated in accordance with the set of parameters and a mapping rule that is based on a quantity of parts included in the report.

A non-transitory computer-readable medium storing code for wireless communication at a network entity is described. The code may include instructions executable to output a control message that indicates a set of parameters for reporting a compressed representation of a set of multiple coefficients for a precoding matrix, the set of multiple coefficients corresponding to a set of multiple downlink subbands associated with SBFD operations and obtain a report that indicates the compressed representation of the set of multiple coefficients in response to outputting the control message, where the report is generated in accordance with the set of parameters and a mapping rule that is based on a quantity of parts included in the report.

In some examples of the method, apparatuses, and non-transitory computer-readable medium described herein, the report includes a first part that indicates a quantity of coefficients included in the set of multiple coefficients and at least a second part that indicates one or more mappings for the set of multiple coefficients, the one or more mappings may be based on the mapping rule, and the first part and at least the second part indicate the compressed representation of the set of multiple coefficients.

In some examples of the method, apparatuses, and non-transitory computer-readable medium described herein, the second part of the report indicates a first mapping for a first portion of the set of multiple coefficients and a second mapping for a second portion of the set of multiple coefficients, the first portion correspond to a first downlink subband of the set of multiple downlink subbands, and the second portion corresponds to a second downlink subband of the set of multiple downlink subbands.

In some examples of the method, apparatuses, and non-transitory computer-readable medium described herein, the second part of the report indicates a mapping for the set of multiple coefficients and the mapping may be based on the mapping rule.

In some examples of the method, apparatuses, and non-transitory computer-readable medium described herein, the second part of the report indicates a first mapping for a first portion of the set of multiple coefficients and a third part of the report indicates a second mapping for a second portion of the set of multiple coefficients, the first portion corresponds to a first downlink subband of the set of multiple downlink subbands, and the second portion corresponds to a second downlink subband of the set of multiple downlink subbands.

In some examples of the method, apparatuses, and non-transitory computer-readable medium described herein, the set of parameters includes a same set of parameters for each subband of the set of multiple downlink subbands.

In some examples of the method, apparatuses, and non-transitory computer-readable medium described herein, the set of parameters includes a respective subset of parameters for each subband of the set of multiple downlink subbands.

In some examples of the method, apparatuses, and non-transitory computer-readable medium described herein, the report includes a field that indicates a quantity of coefficients included in the set of multiple coefficients and the field may be based on a quantity of reporting subbands associated with the set of multiple downlink subbands or the set of parameters, or both.

In some examples of the method, apparatuses, and non-transitory computer-readable medium described herein, a first portion of the set of multiple coefficients that corresponds to a first downlink subband of the set of multiple downlink subbands may be aligned in accordance with a first coefficient of the set of multiple coefficients and a second portion of the set of multiple coefficients that correspond to a second downlink subband may be aligned in accordance with the first coefficient or a second coefficient of the set of multiple coefficients and the compressed representation of the set of multiple coefficients may be based on the alignment of the first portion and the second portion.

In some examples of the method, apparatuses, and non-transitory computer-readable medium described herein, a quantity of reporting subbands associated with the set of multiple downlink subbands satisfies a threshold and the compressed representation of the set of multiple coefficients may be based on a first set of coefficients selected from the first portion and a second set of coefficients selected from the second portion, the first set of coefficients and the second set of coefficients may be based on the quantity of subbands satisfying the threshold.

### BRIEF DESCRIPTION OF THE DRAWINGS

FIGS. 1 and 2 each illustrate an example of a wireless communications system that supports parameter reporting for multiple subbands in accordance with one or more aspects of the present disclosure.

FIG. 3 illustrates an example of a coefficient mapping scheme that supports parameter reporting for multiple subbands in accordance with one or more aspects of the present disclosure.

FIGS. 4A and 4B each illustrate an example of a payload structure that supports parameter reporting for multiple subbands in accordance with one or more aspects of the present disclosure.

FIGS. 5A and 5B each illustrate an example of a coefficient alignment scheme that supports parameter reporting for multiple subbands in accordance with one or more aspects of the present disclosure.

FIGS. 6A and 6B each illustrate an example of a basis selection scheme that supports parameter reporting for multiple subbands in accordance with one or more aspects of the present disclosure.

FIG. 7 illustrates an example of a process flow that supports parameter reporting for multiple subbands in accordance with one or more aspects of the present disclosure.

FIGS. 8 and 9 illustrate block diagrams of devices that support parameter reporting for multiple subbands in accordance with one or more aspects of the present disclosure.

FIG. 10 illustrates a block diagram of a communications manager that supports parameter reporting for multiple subbands in accordance with one or more aspects of the present disclosure.

FIG. 11 illustrates a diagram of a system including a device that supports parameter reporting for multiple subbands in accordance with one or more aspects of the present disclosure.

FIGS. 12 and 13 illustrate block diagrams of devices that support parameter reporting for multiple subbands in accordance with one or more aspects of the present disclosure.

FIG. 14 illustrates a block diagram of a communications manager that supports parameter reporting for multiple subbands in accordance with one or more aspects of the present disclosure.

FIG. 15 illustrates a diagram of a system including a device that supports parameter reporting for multiple subbands in accordance with one or more aspects of the present disclosure.

FIGS. 16 through 18 illustrate flowcharts showing methods that support parameter reporting for multiple subbands in accordance with one or more aspects of the present disclosure.

### DETAILED DESCRIPTION

Some wireless communications systems may support precoding operations for directional communications. For example, wireless communication devices operating within a wireless communications system, such as user equipment (UE) and network entities, may apply beamforming to communicate via directional transmissions (e.g., beams). In some examples of beamforming, such as for digital beamforming, a network entity may apply signal processing techniques to select, shape, or steer a beam along a spatial path between the network entity and a UE. Additionally, or alternatively, a spatial direction of the formed beam may depend on a set of parameters applied at the network entity. For example, the set of parameters may include a precoding matrix, which may also be referred to as a precoder. In some cases, the network entity may select a precoder (e.g., associated with a beam) for directional communications based on channel state feedback (CSF) from the UE. For example, the UE may use a codebook to provide CSF to the network entity for multiple subbands. In some examples, such as for Type-II codebooks, the UE may determine a precoder for each subband. For instance, the UE may identify a set of spatial beams and a corresponding set of coefficients for the multiple subbands. The set of coefficients may include an aggregate of respective coefficients associated with each subband. In some cases, the UE may transmit a CSF report to the network entity that indicates the set of spatial beams and the corresponding set of coefficients, and the network entity may use the CSF report (e.g., the indicated set of spatial beams and corresponding set of coefficients) to reconstruct or generate a precoder for each subband.

In some examples, to reduce signaling overhead associated with reporting coefficients for multiple subbands, the UE may use an enhanced Type-II (eType-II) codebook in which the UE reports a compressed representation of the set of coefficients. For example, the UE may use a basis set to compress the set of coefficients in the frequency domain and reduce the quantity of coefficients, thereby reducing the overhead associated with the transmission of the CSF report. In such cases, the CSF report may indicate the set of spatial beams, the compressed representation (e.g., a compressed mapping) of the set of coefficients, and the basis set used for to compress the set of coefficients. In some examples, the basis set may be selected at or by the UE based on a frequency correlation between coefficients of different subbands. For example, the basis set may be based on two or more subbands in which a correlation between the coefficients of the two or more subbands may be relatively high (e.g., may exceed a threshold correlation).

In some examples, the network entity may communicate with the UE in accordance with subband full-duplex (SBFD) operations. In such examples, downlink subbands used at the network entity (e.g., for downlink communications between the network entity and the UE) may be non-contiguous in frequency. As such, the network entity may configure the UE to report CSF for non-contiguous downlink subbands. In such cases, however, the likelihood of coefficients associated with non-contiguous subbands being correlated may be relatively low (e.g., coefficients associated with non-contiguous subbands may have low correlation or may be uncorrelated). That is, a relatively high correlation between coefficients associated with non-contiguous subbands may be unlikely and compression for non-contiguous subbands may be ineffective as the basis set selection depends, at least in part, on the correlation between coefficients. In some examples, to improve the efficacy of compression for coefficients associated with non-contiguous subbands, the UE may compress respective sets of coefficients for each subband (e.g., independently). In such examples, however, the UE may lack a mechanism or procedure for indicating multiple sets of coefficients for multiple subbands in a single report. Further, transmitting multiple reports for multiple subbands may lead to increased signaling overhead.

Aspects of the present disclosure generally relate to techniques for parameter reporting for multiple subbands, and more specifically, to a framework for reporting precoding matrix coefficients for multiple subbands in a single report. For example, a network entity may provide the UE with a configuration for reporting a compressed representation of coefficients for a precoding matrix, in which the coefficients correspond to multiple downlink subbands associated with SBFD operations. In some examples, the configuration may include a same set of parameters to be used at the UE across the multiple downlink subbands or a respective set of parameters to be used for each downlink subband. In such examples, the UE may use the configuration and a mapping rule to generate a report that indicates the compresses representation of the coefficients. In some examples, the mapping rule may be based on a quantity of parts included in the report. For example, a payload structure of the report may include two parts and the UE may use a first rule in which the coefficients for multiple downlink subbands may be mapped together and reported in a part (e.g., a single part) of the report. In some other examples, the payload structure of the report may include more than two parts, and the UE may use a second rule in which each set of coefficients associated with a downlink subband may be mapped and reported in a respective part of the report. That is, the report may include multiple parts that each include a mapping of a respective set coefficients associated with a respective downlink subband. In some examples, the UE may report a same quantity of coefficients for each downlink subband or multiple (e.g., different) quantities of coefficients for the multiple downlink subbands. Further, in some examples, the UE may sort multiple sets of coefficients together (e.g., using a same reference coefficient) or the UE may sort each set of coefficients individually (e.g., using respective reference coefficient for each set), and the UE may transmit the report to the network entity for use in reconstructing the precoding matrix.

Aspects of the subject matter described herein may be implemented to realize one or more of the following potential advantages. For example, the techniques employed by the described communication devices (e.g., the UE, the network entity) may provide benefits and enhancements to the operation of the communication devices, including CSF reporting for SBFD operations. In some examples, operations performed by the described communication devices may provide improvements to CSF reporting within a wireless communications system. In some examples, the operations performed by the described communication devices to improve CSF reporting may include reporting precoding matrix coefficients for multiple subbands in a single CSF report. In some examples, operations performed by the described communication devices may also support increased reliability and throughput of wireless communications within the wireless communications system, among other benefits.

Aspects of the disclosure are initially described in the context of wireless communications systems. Aspects of the disclosure are also described in the context of a coefficient mapping scheme, payload structures, coefficient alignment schemes, basis selection schemes, and a process flow. Aspects of the disclosure are further illustrated by and described with reference to apparatus diagrams, system diagrams, and flowcharts that relate to parameter reporting for multiple subbands.

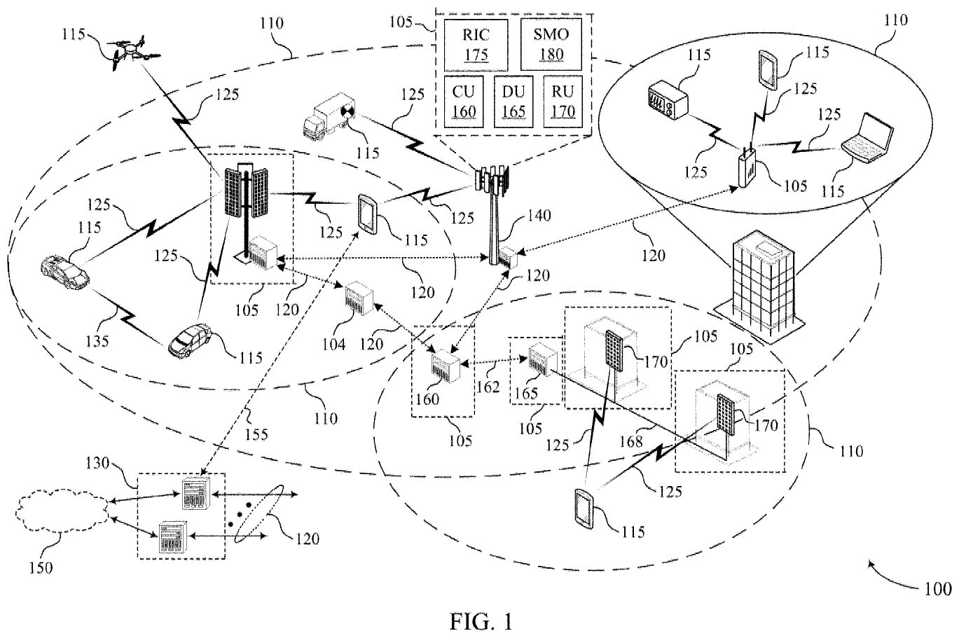

FIG. 1 illustrates an example of a wireless communications system 100 that supports parameter reporting for multiple subbands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support parameter reporting for multiple subbands as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more subbands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a network entity 105 may communicate with a UE 115 in accordance with SBFD operations. In such examples, downlink subbands used at the network entity 105 for downlink communications between the network entity 105 and the UE 115 may be non-contiguous in frequency. As such, the UE 115 may report CSF for non-contiguous downlink subbands. In some examples, however, a relatively high correlation between coefficients associated with non-contiguous subbands may be unlikely. Accordingly, compression for non-contiguous subbands may be ineffective due to basis set selection (e.g., for compression of the coefficients associated with the non-contiguous subbands) being dependent on a correlation (e.g., a frequency correlation) between coefficients associated with different subbands. In some examples, the UE 115 may determine to compress respective sets of coefficients for each subband independently. In such examples, however, the UE 115 may lack a mechanism for indicating multiple sets of coefficients for multiple subbands in a single report. Further, transmitting multiple reports for multiple subbands may lead to increased signaling overhead associated with transmitting a CSF report to the network entity.

According to aspects herein, the UE 115 may support a framework for reporting precoding matrix coefficients for multiple subbands in a single report. For example, the network entity 105 may provide the UE 115 with a configuration (e.g., a set of parameters) for reporting a compressed representation of coefficients correspond to multiple downlink subbands associated with SBFD operations. For example, the UE 115 may receive a control message from the network entity 105 that indicates the set of parameters. The UE 115 may generate a report that indicates the compressed representation of the coefficients. In such examples, the report may be generated in accordance with the set of parameters and a mapping rule, which may be based on a quantity of parts included in the report. Further, in some examples, the UE 115 may transmit the report to the network entity 105. Generating the report based on the set of parameters and the mapping rule in accordance with aspects herein may lead to reduced signaling overhead associated with CSF reporting, among other possible benefits.

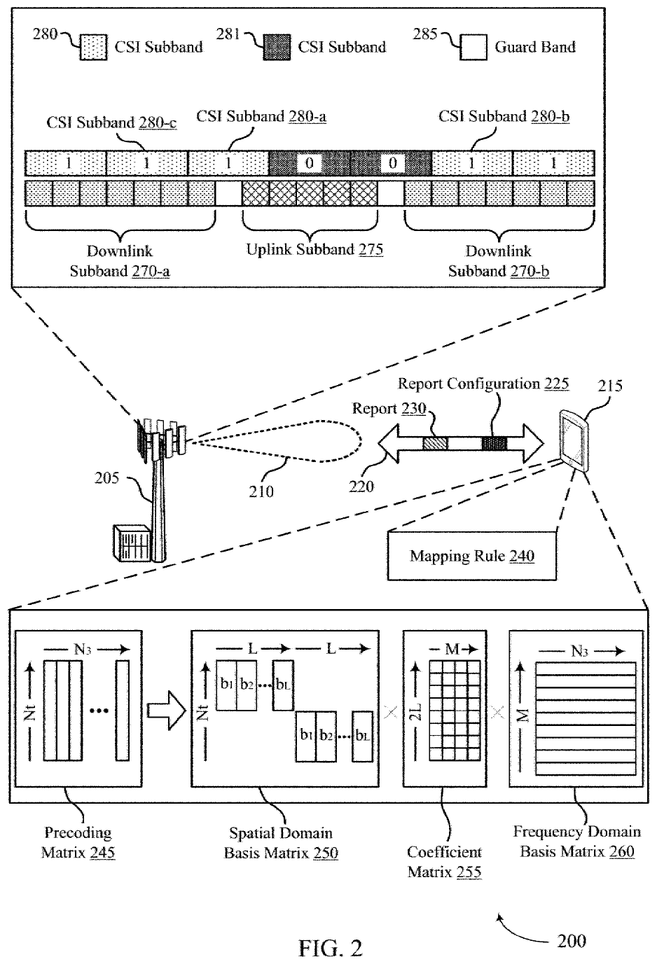

FIG. 2 illustrates an example of a wireless communications system 200 that supports parameter reporting for multiple subbands in accordance with one or more aspects of the present disclosure. The wireless communications system 200 may implement or be implemented at one or more aspects of the wireless communications system 100. For example, the wireless communications system 200 may include a UE 215 and a network entity 205, which may be examples of the corresponding devices illustrated by and described with reference to FIG. 1. The network entity 205 may communicate with the UE 215 via a communication link 220, which may be an example of a communication link illustrated by and described with reference to FIG. 1. For example, the communication link 220 may be an example of a downlink or an uplink (e.g., a Uu interface).

In some examples of the wireless communications system 200, the network entity 205 and the UE 215 may support one or more full-duplex operations, such as in-band full-duplex (IBFD) or SBFD, or both. SBFD operations may correspond to full-duplex operations in which one or more subbands used for downlink communications may be non-overlapping with a subband used for uplink communications. IBFD operations may correspond to full-duplex operations in which a subband used for downlink communications may overlap (e.g., fully overlap or partially overlap) with a subband used for uplink communications. In some examples, such full-duplex operations may enable the network entity 205 to simultaneously transmit communications to and receive communications from one or more UEs (e.g., including the UE 215).

In some examples, the network entity 205 and the UE 215 may support operations in a multiple TRP mode. In such examples, downlink transmissions and uplink receptions at the network entity 205 may occur at multiple (e.g., two different) antenna panels located at multiple (e.g., two different) TRPs. For example, the reception of uplink communications may occur at an antenna panel of a first TRP and the transmission of downlink communications may occur at an antenna panel of a second TRP. In some other examples, reception of the uplink communications and transmission of the downlink communications may occur at two co-located antenna panels of the network entity 205 (e.g., a single base station). In some examples, the TRP used for uplink receptions may experience cross-link interference. In some examples, cross-link interference may result from energy leakage due to timing and frequency unalignment (e.g., misalignment) between the neighboring communication devices (e.g., the UE 215 and another UE).

In some other examples of the wireless communications system 200, the network entity 205 may operate in a full duplex mode and the UE 215 may operate in a half-duplex mode, such as a half-duplex TDD mode. That is, the network entity 205 may perform full-duplex wireless communications, while the UE 215 may perform half-duplex TDD wireless communications. For example, the wireless communications system 200 may support TDD radio frequency bands, FDD radio frequency bands, full duplex communications at the network entity 205, half duplex communications at the UE 215, or any combination thereof. In some examples, the network entity 205 may support multiple types of full-duplex operations. For example, the network entity 205 may support IBFD operations, SBFD operations, or both. In other words, the network entity 205 may support full-duplex communications using downlink subbands and uplink subbands that are non-overlapping in frequency (e.g., SBFD operations) or full-duplex communications using downlink subbands and uplink subbands that are fully or partially overlapping (e.g., IBFD operations), or both.

In some examples of IBFD operations, the network entity 205 may transmit and receive wireless communications on a same time and frequency resource (e.g., a same slot and component carrier bandwidth). For example, downlink communications and uplink communications may the share time and frequency resources (e.g., IBFD time and frequency resources). In some examples, the time and frequency resources may partially overlap or fully overlap. Additionally, or alternatively, in some examples of SBFD operations (e.g., flexible duplex operations), the network entity 205 may transmit and receive communications at a same time, but on different frequency resources. For example, the network entity may use a same time resource and multiple (e.g., different) frequency resources for downlink and uplink communications. In other words, a downlink resource may be non-overlapping with (e.g., separated from) an uplink resource in the frequency domain.

In some examples, full-duplex communications may provide for latency reduction. For example, the network entity 205 may support SBFD operations, such that downlink communications transmitted from the network entity 205 may overlap in time with uplink communications received at the network entity 205. In such an example, latency savings may be enabled at the network entity 205 by receiving downlink signal in uplink slots. Moreover, full-duplex communications may provide for spectrum efficiency enhancement (e.g., per cell or per UE), efficient resource utilization, and coverage extension, among other benefits. In some examples, however, full-duplex communications may lead to one or more types of interference, such as inter-cell interference (e.g., from neighboring communication devices), self-interference (e.g., for full-duplex communication devices), and cross-link interference (e.g., inter-cell cross-link interference or intra-cell cross-link interference). For example, the network entity 205 may experience self-interference between a pair of beams, such as a beam 210 used for communications with the UE 215 and another beam used for communications with another UE. In some examples, the self-interference may result from signal leakage between an antenna panel used to transmit communications and another antenna panel used to receive communications.

In some examples, half-duplex communications at the UE 215 may lead to cross-link interference. For example, uplink communications transmitted from the UE 215 may interfere with downlink communications received at another UE (e.g., a neighboring UE). That is, neighboring UEs may concurrently perform half-duplex TDD communications such that uplink signals transmitted by one UE may overlap with downlink signals received by another UE, which may lead to cross-link interference. In some examples, the neighboring UEs may be operating in a same cell or different cells (e.g., adjacent cells).

In some examples, the network entity 205 may indicate a time and a frequency location (e.g., a time-frequency location) of one or more downlink subbands or one or more uplink subbands, or both, to the UE 215. For example, the network entity 205 may indicate one or more resource allocations (e.g., in symbols) with one or more subbands (e.g., downlink subbands, uplink subbands). In some examples, UE 215 may perform CSI measurements for one or multiple subbands and provide feedback (e.g., a CSF report) to the network entity 205 based on the CSI measurements. For example, the wireless communications system 200 (e.g., the network entity 205, the UE 215) may support a framework for CSF reporting in which the network entity may transmit reference signals (e.g., CSI-RS) to the UE 215 and the UE 215 may perform CSI measurements on reference signals to estimate a communication channel associated with each of the multiple subbands. In such an example the UE 215 may provide CSF (e.g., transmit a CSF report) to the network entity 205 to indicate the communication channel estimate for the multiple downlink subbands to the network entity 205. In some examples, the UE 215 may use a codebook to provide the CSF to the network entity 205. For example, the UE 215 may support a Type-II codebook in which the UE 215 may use (e.g., report) a linear combination of DFT beams to capture spatial domain sparsity of the communication channel (e.g., the communication channel estimated based on the CSI measurements). In some examples, coefficients associated with the DFT beams may be reported to the network entity 205. For example, the UE 215 may report coefficients per beam or per subband, or both. In such an example, a relatively large quantity subbands or beams (e.g., the quantity may exceed a threshold quantity), or both, may lead to relatively high overhead (e.g., about 682 bits for rank-2 and 13 subbands, or another threshold quantity of bits for different rank and subband combinations) for the UE 215.

In some examples, to reduce signaling overhead associated with reporting coefficients for the quantity of subbands or beams, the wireless communications system 200 may support a CSI Type II codebook enhancement (e.g., an eType-II codebook) in which the UE 215 may report a compressed representation (e.g., a mapping) of the set of coefficients. For example, the UE 215 may support Type-II CSI in which the UE 215 may use frequency domain compression of a linear combination of the coefficients via a DFT bases (e.g., a set of DFT basis vectors). In such an example, after compression, the coefficients may be sparse in a delay domain. In some examples, a Type-II CSI report (e.g., an eType-II CSI report) may indicate spatial beams, coefficients (e.g., in the delay domain), and the frequency domain compression bases (e.g., the DFT bases). For example, to generate an eType-II CSI report, the UE 215 may calculate a precoder on each subband (e.g., as a linear combination of spatial beams), aggregate coefficients on each subband (e.g., per layer), and perform frequency domain compression of the coefficients via a DFT basis. In such an example, the eType-II CSI report may indicate sparse linear coefficients in the delay domain (e.g., compared to other CSI reports that may indicate linear coefficients in the frequency domain). In some examples, frequency domain compression may reduce overhead while preserving (or improving) a performance of the CSI report. Additionally, or alternatively, eType-II CSI reporting may provide for relatively finer quantization and support a relatively higher rank (e.g., up to about rank-4).

In some examples, the network entity 205 may configure the UE 215 to provide CSF for a quantity of layers (e.g., data streams) used at the network entity 205 (e.g., for a downlink transmission). In some examples, the quantity of layers (l) may be configured at the UE 215 (e.g., via signaling from the network entity 205, such as RRC signaling). Additionally, the network entity 205 may the UE 215 to report (e.g., via the CSF) a PMI for a quantity of subbands (e.g., for a quantity of PMI subbands, such as N₃ PMI subbands) and a channel quality indicator (CQI) for a quantity of subbands (e.g., a quantity of CQI subbands). In such an example, the quantity of PMI subbands may be the same as (or different from) the quantity of CQI subbands. In some examples of an eType-II codebook structure, precoders for a layer (l) across the quantity of PMI subbands may be given by a matrix (W^{(l)}). In such examples, a size (e.g., dimensions) of the matrix (e.g., a precoding matrix 245) may depend on a quantity of antennas (e.g., transmit antennas at the network entity 205) and the quantity of PMI subbands. For example, the size of the precoding matrix 245 may be determined in accordance with the following Equation 1:

$${N}_{t} \times {N}_{3} \qquad ( 1 )$$

in which Nₜ may correspond to the quantity of antennas (e.g., active antenna ports at the network entity 205) and N₃ may correspond to the quantity of PMI subbands (e.g., a quantity of radio frequency spectrum bands the network entity 205 may precode over). In some examples, the quantity of PMI subbands may be determined (e.g., at the network entity 205) based on a quantity of CQI subbands (e.g., per CQI subband). In some examples, a CQI subband (or a PMI subband) may correspond to a portion of a bandwidth represented by the reported CQI (or PMI). In some examples, the quantity of CQI subbands and the quantity of PMI subbands may be configured at the UE 215 (e.g., via signaling from the network entity 205, such as RRC signaling).

For example, the quantity of PMI subbands may be determined (e.g., configured) at the UE 215 based on the quantity of CQI subbands and a parameter R. In some examples, the quantity of CQI subbands may be determined in accordance with a high-layer parameter, such as a csi-ReportingBand information element (IE). Additionally, in some examples, the parameter R (e.g., R={1,2}) may be configured via another parameter, such as a numberOfPMISubbandsPerCQISubband IE. In some examples, such as for R=1, the parameter N₃ may be equal to the quantity of CQI subbands (e.g., possible values ranging from about 1 to about 19). In some other examples, such as for such as for R=2, the quantity of CQI subbands may have a value ranging from about 1 to about 37. In some examples, such as for edge CQI subbands, a PMI subband size may be relatively finer than (e.g., about half of) the CQI subband size. For example, if the quantity of resource blocks (RBs) is less than or equal to half of the nominal CQI subband size, the UE may report 1 PMI. Additionally, or alternatively, if the quantity of RBs is greater than half of the nominal CQI subband size (or is some other suitable quantity of RBs), the UE 215 may report 2 PMIs.

In some examples, for transmit layer (l), the precoding matrix 245 (e.g., a compressed Type II precoder (W^{(l)})) may exploit a sparsity of the spatial domain and the frequency domain. For example, a CSI formula for an eType II codebook may be used to indicate the precoding matrix 245 using a structure described in accordance with Equation 2:

$${W}^{( l )} = {W}_{1} {W}_{2 , l} {W}_{f , l}^{H} \qquad ( 2 )$$

in which W^{(l)} may represent the precoding matrix 245, W₁ may represent a spatial domain basis matrix 250 (e.g., a set of spatial domain basis, a set of spatial beams, a spatial domain basis selection), W_{2,l} may represent a coefficient matrix 255 (e.g., a set of spatial and frequency domain channel coefficients, a coefficient selection), and W_{f}^{H} may represent a frequency domain basis matrix 260 (e.g., a set of frequency domain bases, a frequency domain compression basis selection). In some examples, the precoding matrix 245 (e.g., represented using the matrix W^{(l)}) may include a quantity of rows (Nₜ) that may be described in accordance with Equation 3:

$${N}_{t} = 2 {N}_{1} {N}_{2} \qquad ( 3 )$$

in which N₁ may represent the spatial domain and N₂ may represent a quantity of antenna ports at the network entity 205. Additionally, or alternatively, the precoding matrix 245 may include a quantity of columns (N₃) that may each represent a frequency domain compression unit (e.g., including RBs or reporting subbands, which may be referred to as CSI subbands).

In some examples, the spatial domain basis matrix 250 (e.g., a spatial domain precoder represented using the matrix W₁) may include spatial domain bases that consider (e.g., include, account for) a quantity of beams (L) (e.g., to be used at the network entity 205). That is, the matrix W₁ may include a quantity of spatial domain bases that may be based on (e.g., correspond to) a quantity of beams (L) at the network entity 205. For example, the spatial domain basis matrix 250 may include a quantity of columns (L) per polarization group (e.g., about 2L beams). In such an example, an i-th column of the matrix W₁ may correspond to the i-th beam (bᵢ). In some examples, the spatial domain basis matrix 250 (e.g., the matrix W₁) may be common to multiple layers (l). That is, for some transmissions (e.g., multi-stream MIMO transmissions) a same set of spatial domain bases (e.g., spatial domain basis vectors) may be used for multiple layers (e.g., each layer (l)). In some examples, the spatial domain basis matrix 250 (e.g., spatial domain bases, basis vectors in the spatial domain, DFT basis vectors) may be represented in accordance with the following Equation 4:

$${N}_{t} \times 2 L \qquad ( 4 )$$

in which L beams may be selected (e.g., at the network entity 205) for each polarization group. Additionally, or alternatively, the parameter L may be configured at the UE 215 (e.g., via signaling from the network entity 205, such as via RRC signaling). In some examples, CSI reported from the UE 215 to the network entity 205 may be based on the parameter L (e.g., and one or more other parameters to be used for the downlink transmission, such as the quantity of CQI subbands, the quantity of PMI subbands and the quantity of layers (l)).

In some examples, the coefficient matrix 255 (e.g., represented using the matrix W_{2,l}) may include a linear combination of coefficients (e.g., amplitude and co-phasing coefficients), in which each element (e.g., of the matrix W_{2,l}) may represent the coefficient of a tap for a beam. Additionally, or alternatively, the coefficient matrix 255 (e.g., the matrix W_{2,l}) may be layer-specific. That is, for some transmissions (e.g., multi-stream MIMO transmissions), multiple (e.g., different) sets of coefficients (e.g., each corresponding to a respective coefficient matrix) may be used for multiple (e.g., different) layers (l). In some examples, such as for a Type-II (or an eType-II) precoding matrix composition for layer (l), a row of the matrix W_{2,l} may correspond to a spatial beam and in the matrix W₁ and an entry (e.g., of the matrix W_{2,l}) may represent the coefficient of a tap for the spatial beam. As such, a size of the coefficient matrix W_{2,l}, (e.g., the coefficient matrix 255) may be represented in accordance with the following Equation 5:

$$2 L \times M \qquad ( 5 )$$

in which the parameter 2L may correspond to the quantity of spatial beams included in the spatial domain basis matrix 250 (e.g., a spatial beam matrix) and the parameter M may correspond to the quantity of frequency domain bases included in the frequency domain basis matrix 260. That is, columns of the matrix W_{2,l}, may correspond to the rows of the frequency domain basis matrix 260 and rows of the matrix W_{2,l}, may correspond to the columns of the spatial domain basis matrix 250. In some examples, the parameter L may have a value ranging from about 2 to about 6 (e.g., L={2,4,6}). That is, eType-II CSI may support an increased quantity of beam combinations (e.g., may support up to about a 6-beam combination, whereas other CSI reports may support up to about a 4-beam combination).

In some examples, the parameter M may be configured (e.g., RRC configured) at the network entity 205 and the UE 215. For example, the network entity may indicate the parameter M to the UE 215 via RRC signaling. Additionally, or alternatively, M may be based on (e.g., may be a function of) RI. Additionally, or alternatively, the coefficient matrix 255 (e.g., represented using the matrix W_{2,l}, which may including 2L×M elements) may include a quantity (e.g., a maximum quantity or an otherwise suitable quantity) of coefficients (e.g., K₀ non-zero coefficients for a layer and 2K₀ non-zero coefficients for multiple layers). That is, for a single layer the UE 215 may report K₀ non-zero coefficients and across multiple (e.g., all) layers the UE 215 may report 2K₀ non-zero coefficients (e.g., within the coefficient matrix 255) to the network entity 205. In some examples, a value of unreported coefficients may be set to zero (e.g., at the network entity 205). In some examples, the parameter K₀ may be determined in accordance with the following Equation 6:

$${K}_{0} = ⌈ β \times 2 {LM}_{1} ⌉ \qquad ( 6 )$$

in which the parameter β may be RRC configured and correspond to an offset (e.g., a static, semi-static, or dynamic offset).

In some examples, an entry in the matrix W_{2,l} may correspond to a row of the matrix

$${W}_{f , l}^{H} .$$

For example, the frequency domain basis matrix 260 may include bases (e.g., basis vectors in the frequency domain, DFT basis vectors) used to perform compression in the frequency domain. That is, each row of the matrix

$${W}_{f , l}^{H}$$

may correspond to a basis vector. Additionally, or alternatively, the frequency domain basis matrix 260 (e.g., represented using the matrix

$${W}_{f , l}^{H} )$$

may be layer-specific. That is, for some transmissions (e.g., multi-stream MIMO transmissions), multiple (e.g., different) sets of frequency domain basis matrix 260 may be uses for multiple (e.g., different) layers (l). In some examples, the quantity of bases (e.g., vectors) included in the frequency domain basis matrix 260 may be rank-pair-specific (e.g., M₁=M₂ for RI={1,2}, and M₃=M₄ for RI={3,4}, in which M₁, M₂, M₃, M₄ may be RRC configured). In some examples, a size of the frequency domain basis matrix 260 may be represented in accordance with the following Equation 7:

$$M \times {N}_{3} . \qquad ( 7 )$$

In some examples, M₁, M₂, M₃, and M₄ may be determined in accordance with the following Equation 8:

$${M}_{1} = {M}_{2} = [ {p}_{1} \times \frac{{N}_{3}}{R} ] and {M}_{3} = {M}_{4} = [ {p}_{3} \times \frac{{N}_{3}}{R} ] \qquad ( 8 )$$

in which the parameter p (e.g., p₁ and p₃) may correspond to an overhead scaling factor. In some examples, the quantity of spatial domain bases (e.g., a value of L), the quantity of frequency domain bases (e.g., respective values of p₁ and p₃), and the quantity of non-zero coefficients (e.g., a value of β) may be configured at the UE 215 via RRC signaling (e.g., from the network entity 205). For example, the network entity 205 may configure a combination of (L, p₁, p₃, β) at the UE 215. In some examples, the network entity 205 may configure 1 combination out of 8 (or some other suitable quantity) of possible combinations.

In some examples (e.g., for PMI Type-I, PMI Type-II, and PMI eType-II), a quantity of PMI subbands may be equal to a quantity of CQI subbands. In such examples, a quantity of subbands for the CSF (e.g., a quantity of CSI subbands) may be determined in accordance with one or more rules. For example, downlink subbands for SBFD slots, such as downlink subbands 270, may be non-contiguous in frequency. That is, a downlink subband 270-a and a downlink subband 270-b may be non-contiguous in frequency (e.g., separated in the frequency domain by an uplink subband 275). In such an example (e.g., for SBFD slots PMI), subband determination may be in accordance with (e.g., follow) one or more rules of CQI subbands. That is, in some examples, a determination of which (e.g., a quantity of) PMI subbands the UE 215 may report CSI for may follow a CSI subband granularity. For example, for PMI eType-II, the network entity 205 may configure the UE 215 to use (e.g., to report CSF for) a quantity of PMI subbands that may be equal to or greater than (e.g., approximately double) the quantity of CQI subbands. In the example of FIG. 2, PMI subbands may be referred to as CSI subbands.

In some examples, the network entity 205 may use a bitmap to configure the UE 215 with one or more of the CSI subbands 280, to use for CSF reporting. For example, the wireless communications system 200 may supports selection of non-contiguous CSI subbands (e.g., the CSI subbands 280) for reporting via a bitmap. In some examples, the network entity 205 may indicate selected CSI subbands (e.g., the CSI subbands 280) via a bitmap equal to 1110011 (e.g., a bitmap indicating CSI subbands=1110011). In such an example, the UE 215 may be configured to report CSF for subbands with a value of 1 (e.g., the CSI subbands 280) and refrain from reporting CSF for subbands with a value of 0 (e.g., CSI subbands 281). For such a configuration, the CSI subbands 280 may include subbands that are non-contiguous in frequency, such as a CSI subband 280-a and a CSI subband 280-b. In some examples, the CSI subband 280-a and the CSI subband 280-b (e.g., subbands with a frequency gap in the middle) may have a lower correlation (e.g., relative to contiguous CSI subbands). For example, a CSI subband 280-c (e.g., the second CSI subband) may have a higher correlation with the CSI subband 280-a (e.g., the third CSI subband) and a lower correlation with the CSI subband 280-b (e.g., the seventh CSI subband). Hence, selection of a frequency domain bases for compression may be reduced (e.g., sub-optimal, relatively inaccurate), for example if compression is performed over the CSI subbands 280 (e.g., all of the CSI subbands 280, which may include some non-contiguous subbands).

In some examples, CSF reporting for non-contiguous CSI subbands may be avoided. For example, the UE 215 may avoid CSF reporting for non-contiguous subbands in TDD if the network entity 205 (e.g., a gNB) configures reporting of contiguous CSI subbands. However, in a SBFD slot, an uplink subband may and one or more guard bands may be in the middle of (e.g., separating, in between) downlink subbands. For example, the uplink subband 275 and guard bands 285 may occur in between the downlink subbands 270. As such, CSI subbands overlapping with the uplink subband 275 (e.g., and the guard bands 285) may be ‘dummy’ subbands. That is, because the network entity 205 may refrain from using the uplink subband 275 to transmit CSI-RS (e.g., because no CSI-RS may transmitted via a subband configured for uplink), the UE 215 may be incapable of reporting CSF for the CSI subbands 281 that overlap with the uplink subband 275 irrespective of whether the network entity 205 configures the UE 215 to report CSF for the CSI subbands 281. In other words, because the UE 215 may not receive CSI-RS via the uplink subband 275, the UE 215 may be incapable of reporting CSF for the CSI subbands 281 overlapping with the uplink subband 275 and, therefore, the CSI subbands 281 overlapping with the uplink subband 275 may be considered ‘dummy’ subbands. Accordingly, the network entity 205 may determine to configure CSI reporting at the UE 215 with non-contiguous CSI subbands (e.g., the CSI subbands 280) in SBFD slots. In such an example, the UE 215 may determine whether to use a common frequency domain basis set across the CSI subbands 280 or multiple (e.g., different) frequency domain basis sets for the CSI subbands 280 (e.g., a different frequency domain basis set for each of the CSI subbands 280). In some examples, a quantity (N_{3_sb}) of CSI subbands 280 included in (e.g., overlapping with) a downlink subband (e.g., the downlink subband 270-a or the downlink subband 270-b) may be less than the quantity (N₃) of CSI subbands 280 (e.g., less than a total quantity of the CSI subbands 280). In some examples, an improvement to frequency domain compression of the coefficients may be achieved through the selection of multiple frequency domain basis sets over non-contiguous CSI subbands. Additionally, in such examples, the improvement may outweigh (e.g., be more beneficial than) a reduction in overhead (e.g., a loss) achieved by using a common frequency domain basis set for non-contiguous CSI subbands.

As illustrated in the example of FIG. 2, the UE 215 may be configured to report CSF for two non-contiguous downlink subbands (e.g., the downlink subband 270-a and the downlink subband 270-b). In some examples, because the UE 215 may use two (e.g., different) frequency domain basis sets for the two non-contiguous downlink subbands, the UE 215 may signal the two frequency domain basis sets (e.g., and the corresponding coefficients) over two reports. In such examples, one of the two downlink subbands (e.g., the downlink subband 270-a or the downlink subband 270-b) may be labeled as a primary subband and the other downlink subband may be labeled as a secondary subband. In some examples, however, transmitting two reports for two downlink subbands may lead to increased signaling overhead. In some other examples, the UE 215 may include the two frequency domain basis sets (e.g., and the corresponding coefficients) in a report (e.g., a single report). In such an example, the UE 215 may use an uplink control information (UCI) payload design and one or more priority rules that support CSF reporting for multiple subbands in the report. In some examples, a gain (e.g., an improvement, an increase in performance) may be obtained from avoiding frequency domain basis selection over non-contiguous CSI subbands (e.g., for improve compression). Additionally, in some examples, the gain may outweigh a loss associated with a reduction in the resolution of the frequency domain basis (e.g., as the quantity of the CSI subbands 280 included in a downlink subband is less than the quantity of CSI subband 280, as N_{3_sb}<N₃). In such examples, it may be desirable for the UE 215 to report eType-II PMI (e.g., a frequency domain basis set and corresponding coefficients) for each downlink subband (e.g., separately). In such an example, the network entity 205 may configure the UE 215 (or the UE 215 may be otherwise configured) with a mechanism for reporting multiple (e.g., two or more) frequency domain basis sets and corresponding coefficients in a same report. Additionally, or alternatively, the network entity 205 may configure the UE 215 (or the UE 215 may be otherwise configured) to determine a respective priority of multiple (e.g., different) parts of the report. That is, in some examples, the UE 215 and the network entity 205 may support a framework for reporting precoding matrix coefficients for multiple subbands in a single report.

For example, the network entity 205 may transmit a report configuration 225 to the UE 215. In some examples, the report configuration 225 may indicate a set of parameters for reporting a compressed representation of coefficients for a precoding matrix. In such examples, the coefficients may correspond to multiple downlink subbands associated with SBFD operations (e.g., the downlink subband 270-a and the downlink subband 270-b). For example, a first portion of the coefficients may correspond to a first set of coefficients included in a first channel coefficient matrix associated with the downlink subband 270-a and a second portion of the coefficients may correspond to second set of coefficients included in a second channel coefficient matrix associated with the downlink subband 270-b. The first channel coefficient matrix and the second channel coefficient matrix may each be an example of the coefficient matrix 255. In some examples, the report configuration 225 (e.g., an eType-II reporting configuration for downlink subbands) may include a same configuration (e.g., a same set of parameters) to be used for both the downlink subband 270-a and the downlink subband 270-b. That is, the report configuration 225 may include a same set of parameters for each of the downlink subbands 270. For example, the report configuration 225 may include a same parameter combination (e.g., a same combination of (L, p₁, p₃, β)) and a same quantity of frequency domain bases. In such an example, the frequency domain basis set and corresponding coefficients indicated via the report 230 may be different (or the same) for the two downlink subbands (e.g., the downlink subband 270-a and the downlink subband 270-b). In some other examples, the report configuration 225 (e.g., the eType-II reporting configuration for downlink subbands) may include multiple configurations. That is, the set of parameters may include multiple subsets of parameters for the downlink subband 270-a and the downlink subband 270-b. For example, the report configuration 225 may indicate a subset (e.g., a different subset) of parameters for each downlink subband (e.g., for the downlink subband 270-a and the downlink subband 270-b). That is, the report configuration 225 may include a respective subset of parameters for each of the downlink subbands 270. In some examples, such as for asymmetric downlink subbands, a different quantity of frequency domain bases may be used for the two downlink subbands. That is, the subset of parameters may indicate a respective quantity of frequency domain bases for each of the downlink subbands 270.

In some examples, the UE 215 may use the report configuration 225 and a mapping rule 240 to generate a report 230 that indicates the compresses representation of the coefficients. In some examples, the mapping rule 240 may be based on a quantity of parts included in the report 230. That is, the mapping rule 240 may be based on a payload structure (e.g., the payload size) used for the report 230 (e.g., a report that includes per-downlink subband PMI information). For example, the payload structure use for the report 230 may enable the report 230 to include two parts. In such an example, the UE 215 may use a first one or more rules in which the first set of coefficients for the downlink subband 270-a and the second set of coefficients for the downlink subband 270-b may be mapped together and reported in a part of the report (e.g., in a single part of the report, in UCI part 2). In some other examples, the payload structure use for the report 230 may enable the report 230 to include three parts. In such an example, the UE may use a second rule in which the first set of coefficients (e.g., associated with the downlink subband 270-a) may be mapped and reported in a second part of the report (e.g., UCI part 2) and the second set of coefficients (e.g., associated with the downlink subband 270-b) may be mapped and reported in a third part of the report (e.g., UCI part 3). In some examples, the UE 215 may report a same quantity of coefficients for each of the downlink subbands 270. In some other examples, the UE 215 may report multiple (e.g., different) quantities of coefficients for the downlink subbands 270. In some examples, the UE 215 may transmit the report 230 to the network entity 205, such that the network entity 205 may reconstruct the precoding matrix for each of the downlink subbands 270. In some examples, reporting precoding matrix coefficients for the downlink subbands 270 in the report 230 may lead to increased communication reliability within the wireless communications system 200, among other possible benefits.

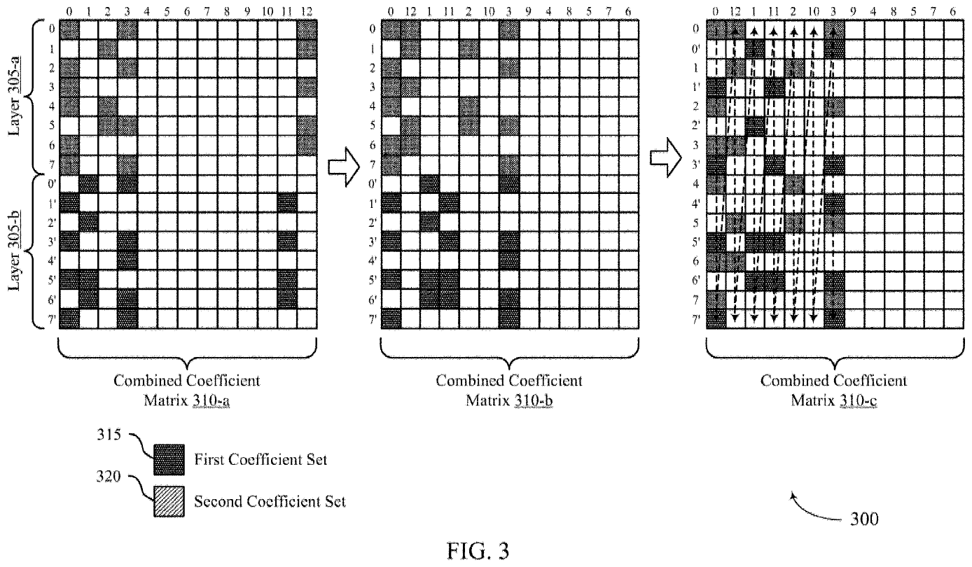

FIG. 3 illustrates an example of a coefficient mapping scheme 300 that supports parameter reporting for multiple subbands in accordance with one or more aspects of the present disclosure. The coefficient mapping scheme 300 may implement or be implemented at one or more aspects of the wireless communications system 100 and the wireless communications system 200. For example, the coefficient mapping scheme 300 may be implemented at a UE or a network entity, which may be examples of the corresponding devices illustrated by and described with reference to FIGS. 1 and 2.

In some examples, the UE may use a report configuration (e.g., a set of one or more parameters) and a mapping rule to generate a report (e.g., an eType-II CSI report) that indicates a compresses representation of coefficients associated with multiple downlink subbands. In some examples, the multiple subbands may include multiple non-contiguous downlink subbands configured for SBFD operations. Additionally, in some examples, the mapping rule may indicate how the UE may order the coefficients (e.g., and a corresponding bitmap) within the report. That is, the UE may use the mapping rule to order the coefficients and may use the report to indicate the ordered coefficients to the network entity.

As illustrated in the example of FIG. 3, the UE may map (e.g., order) multiple sets of coefficients (e.g., non-zero coefficients) in accordance with the mapping rule. For example, a combined coefficient matrix 310-a may include a first coefficient set 315 corresponding to a layer 305-a and a second coefficient set 320 corresponding to a layer 305-b. In some examples, the first coefficient set 315 may correspond to coefficients included in a first coefficient matrix corresponding to layer 305-a and the second coefficient set 320 may correspond to coefficients included in a second coefficient matrix corresponding to layer 305-b. In such examples, the first coefficient matrix and the second coefficient matrix may each be an example of a coefficient matrix 255 as described with reference to FIG. 2. In the example of FIG. 3, a location of the first coefficient set 315 and the second coefficient set 320 within the combined coefficient matrix 310-a may correspond to a first (e.g., original) location of the first coefficient set 315 and the second coefficient set 320, respectively. In some examples, the UE may perform a frequency domain permutation on the combined coefficient matrix 310-a to obtain the combined coefficient matrix 310-b. For example, the UE may perform a frequency domain permutation in accordance with the following Equation 9:

$${m}^{′} = Perm ( m ) \qquad ( 9 )$$

in which m may correspond to a frequency domain basis index. In some examples, coefficients closer to a frequency domain basis with an index of 0 may be more likely to be more significant (e.g., have a higher value), for example relative to coefficients further from the frequency domain basis with the index 0. Accordingly, in some examples, the frequency domain permutation (e.g., the operation Perm (m)) may map the index m in accordance with (e.g., following) an order (e.g., 0, N₃−1, 1, N₃−2, 2, . . . ,) of a corresponding frequency domain component (e.g., if selected). That is, the first coefficient set 315 and the second coefficient set 320 may be organized (e.g., ordered) within the combined coefficient matrix 310-b, such that coefficients with largest values among the first coefficient set 315 (e.g., the strongest coefficients of the first coefficient set 315, the most significant coefficients of the first coefficient set 315) and coefficients with largest values among the second coefficient set 320 (e.g., the strongest coefficients of the second coefficient set 320, the most significant coefficients of the second coefficient set 320) may be located within a first column of the combined coefficient matrix 310-b. In some examples, the first column may be a left most column of the combined coefficient matrix 310-b (e.g., the column corresponding to the frequency domain basis with the index 0). Additionally, coefficients with smallest values among the first coefficient set 315 (e.g., the weakest coefficients of the first coefficient set 315, the least significant coefficients of the first coefficient set 315) and coefficients with the smallest values among the second coefficient set 320 (e.g., the weakest coefficients of the second coefficient set 320, the least significant coefficients of the second coefficient set 320) may be located within a last column of the combined coefficient matrix 310-b. In some examples, the last column may be a right most column of the combined coefficient matrix 310-b occupied by the first coefficient set 315 and the second coefficient set 320. That is, in the example of FIG. 3, the strongest coefficients of the first coefficient set 315 and the strongest coefficients of the second coefficient set 320 may be located in the column of the combined coefficient matrix 310-b with an index of 0. Additionally, in the example of FIG. 3, the weakest coefficients of the first coefficient set 315 and the weakest coefficients of the second coefficient set 320 may be located in the column of the combined coefficient matrix 310-b with an index of 3.

In some examples, the UE may perform layer interleaving on the combined coefficient matrix 310-b to obtain a combined coefficient matrix 310-c. In such examples, the combined coefficient matrix 310-c (e.g., and a corresponding bitmap) may follow a priority function. That is, the coefficients included in the combined coefficient matrix 310-c (e.g., and the corresponding bitmap) may be ordered from high to low in accordance with the following Equation 10:

$$Prio ( l , i , m ) = 2 L \cdot RI \cdot Perm ( m ) + RI \cdot i + l \qquad ( 10 )$$

in which l may correspond to a layer index, i may correspond to a spatial domain basis index, m may correspond to the frequency domain basis index, and RI may correspond to a rank indicator. In some examples, in accordance with Equation 10, the coefficients may be associated with a priority level in which coefficient

$${c}_{{i}_{1} , {m}_{1}}^{( {l}_{1} )}$$

may have a lower priority than coefficient

$${c}_{{i}_{2} , {m}_{2}}^{( {l}_{2} )} ,$$

for example if Prio(l₁, i₁, m₁)>Prio(l₂, i₂, m₂). In some instances, an interpretation of the priority function illustrated by Equation 10 may be such that the UE may map

$${c}_{i , {m}^{′}}^{l}$$

for m′=Perm(m), for i=0:2L−1, and for l=0:Rl−1. In some examples, the UE may order the coefficients (e.g., to be included in the report) of the combined coefficient matrix 310-c in accordance with the mapping rule. For example, the order of the coefficients (e.g., and the corresponding bitmap) to be included in (e.g., indicate via) the report may begin at the column with the index 0 and a row with an index 0 and end at the column with the index 3 and a row with an index 7′.

In some examples, the mapping rule may be based on a quantity of parts included (e.g., to be included) in the report. That is, the mapping rule may be based on a payload structure (e.g., the payload size) used for the report (e.g., a report which includes per-downlink subband PMI information). In some examples, the payload size (e.g., a maximum payload size or an otherwise suitable payload size) may support two UCI parts. That is, in some examples, the CSI payload may be divided into two parts (e.g., UCI part 1 and UCI part 2). In such an example, a quantity of coefficients (e.g., a total number of non-zero coefficients) for the two downlink subbands may be based on a quantity CSI subbands, which may be determined in accordance with the following Equation 11:

$${N}_{3} = {N}_{3 \_ sb 1} + {N}_{3 \_ sb 2} \qquad ( 11 )$$

in which N₃ may represent the quantity of CSI subbands, N_{3_sb1} may represent a quantity of CSI subbands included in (e.g., overlapping in frequency with) a first downlink subband, and N_{3_sb2} may represent a quantity of CSI subbands included in (e.g., overlapping in frequency with) a second downlink subband. In such an example, the mapping rule (e.g., a coefficient mapping rule) may be selected (e.g., updated) based on the CSI payload being divided into two parts (e.g., UCI part 1 and UCI part 2). For example, based on the CSI payload including two parts, the UE may select a subband centric mapping rule. That is, in some examples, the mapping rule may be a first mapping rule that is subband centric. In some examples, in accordance with the first mapping rule, the UE may map coefficients associated with the first downlink subband (e.g., coefficients of layers 0, 1, . . . , l for the first downlink subband) and, for example, subsequently map coefficients associated with the second downlink subband (e.g., coefficients of layers 0, 1, . . . , l for the second downlink subband). In other words, the UE may use the first mapping rule (e.g., and a coefficient priority rule illustrated by Equation 10) to map each downlink subband (e.g., separately). In some examples of the coefficient mapping scheme 300, such as examples in which the UE may be mapping the first coefficient set 315 and the second coefficient set 320 in accordance with the first mapping rule, the layer 305-a may correspond to a first layer (e.g., Layer 0) of the first downlink subband and the layer 305-b may correspond to a second layer (e.g., Layer 1) of the first downlink subband. In such examples, the UE may map the first layer and the second layer of the first downlink subband (e.g., together) in accordance with the first mapping rule (e.g., and the. In some examples, subsequent to mapping the first layer and the second layer of the first downlink subband, the UE may map a first layer (e.g., Layer 0) and a second layer (e.g., Layer 1) of the second downlink subband in accordance with the first mapping rule (e.g., and the coefficient mapping scheme 300).

In some examples, the UE may use a UCI component grouping and a packing order in which the first coefficient set 315 and the second coefficient set 320 (e.g., the non-zero coefficients) may be partitioned into groups, for example to maintain a non-zero PMI (e.g., if a group, such as Group 2, is omitted). In some examples, such as examples in which the CSI payload may include two UCI parts (e.g., and the coefficients may be mapped in accordance with the first mapping rule), the UE may use one or more groups (e.g., Group 1 and Group 2) for UCI components associated with the first downlink subband and one or more other groups (e.g., Group 3 and Group 3) for UCI components associated with the second downlink subband. In some examples, a UCI component may correspond to a set of information included in the UCI part 2 (e.g., a field of the UCI part 2). For example, the UE may group components of UCI part 2 in accordance with the following Table 1:

TABLE 1

| | |
|---|---|
| Group 0 | Spatial basis selection |
| | Strongest coefficient indicator (SCI) |
| Group 1 | Frequency basis selection for first |
| | downlink subband |
| | Reference amplitude for weaker |
| | polarization for first downlink subband |
| | First half of coefficients for first |
| | downlink subband |
| | First part of coefficient selection for first |
| | downlink subband |
| Group 2 | Second half of coefficients for first |
| | downlink subband |
| | Second part of coefficient selection for |
| | first downlink subband |
| Group 3 | Frequency basis selection for second |
| | downlink subband |
| | Reference amplitude for weaker |
| | polarization for second downlink |
| | subband |
| | First half of coefficients for second |
| | downlink subband |
| | First part of coefficient selection for |
| | second downlink subband |
| Group 4 | Second half of coefficients for second |
| | downlink subband |
| | Second part of coefficient selection for |
| | second downlink subband |

in which a packing order may begin at Group 0 and end at Group 4. In some examples, a quantity of physical uplink shared channel (PUSCH) resources allocated to the UE for transmission of the report may be insufficient. In such examples, the UE may omit one or more UCI components in accordance with a UCI omission order, which may depend on the coefficient priority rule.

In some other examples, based on the CSI payload including two parts, the UE may select another mapping rule that supports mapping coefficients of multiple subbands on a combined coefficient matrix. That is, the mapping rule may include a second mapping rule, which may be non-subband centric (e.g., may combine coefficients of multiple subbands). In some examples, in accordance with the second mapping rule, the UE may map the coefficients associated with the first downlink subband with the coefficients associated with the second downlink subband. In some examples, the quantity of layers (e.g., per-subband) may be equal to v. In such examples, the coefficients of layers 0, 1, . . . , v for the second downlink subband may be organized based on the quantity of per-band layers (e.g., as layer v, v+1, . . . ,). Additionally, in such examples, the second mapping rule may be defined based on a quantity of layers across the first downlink subband and the second downlink subband being equal to 2v. For example, in accordance with the second mapping rule, the layer 305-a may correspond to a first layer (e.g., Layer 0) of the first downlink subband and layer 305-b may correspond to a first layer (e.g., Layer 0) of the second downlink subband. That is, the first coefficient set 315 may correspond to a first set of coefficients associated with the first downlink subband and the second coefficient set 320 may correspond to a second set of coefficients associated with the second downlink subband. In such examples, the UE may map the first layer of the first downlink subband and the first layer of the second downlink subband (e.g., together) in accordance with the second mapping rule. In some instances, the first downlink subband and the second downlink subband may include multiple layers. In such an example, and in accordance with the second mapping rule, the UE may stack (e.g., sequentially order) the multiple layers for the first downlink subband and then (e.g., subsequently) stack the multiple layers for the second downlink subband. Additionally, in such an example, the UE may map the multiple layers for the first downlink subband and the multiple layers for the second downlink subband together (e.g., in accordance with the second mapping rule). In some examples, mapping coefficients for multiple subbands in accordance with the mapping rule (e.g., the first mapping rule, the second mapping rule) may lead to improved CSF reporting, among other possible benefits.

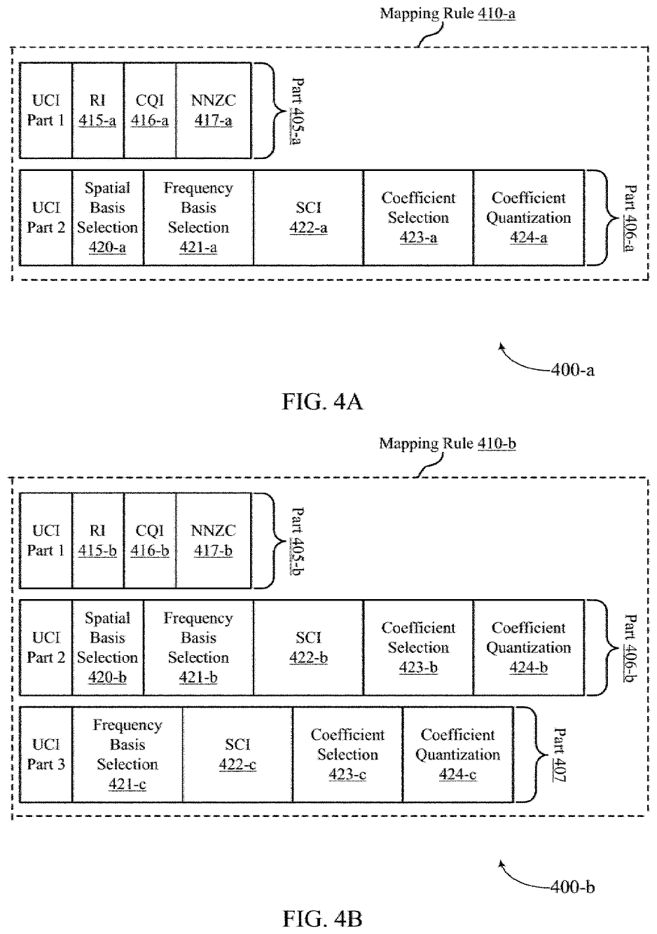

FIGS. 4A and 4B illustrate examples of payload structures 400 that support parameter reporting for multiple subbands in accordance with one or more aspects of the present disclosure. The payload structures 400 (e.g., a payload structure 400-a and a payload structure 400-b) may implement or be implemented at one or more aspects of the wireless communications system 100, the wireless communications system 200, and the coefficient mapping scheme 300. For example, the payload structures 400 may be implemented at a UE or a network entity, which may be examples of the corresponding devices illustrated by and described with reference to FIGS. 1 through 3.

In some examples, the UE may use a report configuration (e.g., a set of one or more parameters) and a mapping rule to generate a report (e.g., an eType-II CSI report) that indicates a compressed representation of coefficients associated with multiple downlink subbands. In some examples, the multiple subbands may include multiple non-contiguous downlink subbands configured for SBFD operations. For example, the coefficients may be associated with a first downlink subband and a second downlink subband configured for SBFD operations. In some examples, the mapping rule may be based on a quantity of parts included (e.g., to be included) in the report. That is, the mapping rule may be based on a payload structure (e.g., the payload size) used for the report (e.g., a report which includes per-downlink subband PMI information).

As illustrated in the example of FIG. 4A, the payload structure 400-a may be such that the report includes two parts. For example, in accordance with the payload structure 400-a, the report may include a part 405-a (e.g., UCI part 1) and part 406-a (e.g., UCI part 2). In some examples of the payload structure 400-a, the part 406-a may be used to indicate one or more mappings for (e.g., one or more compressed representations of) the coefficients. In such examples, the one or more mappings may be based on a mapping rule 410-a. That is, in the example of FIG. 4A, the mapping rule may include the mapping rule 410-a. The mapping rule 410-a may include a first mapping rule or a second mapping rule. In some examples, the first mapping rule and the second mapping rule may be examples of a first mapping rule and a second mapping rule, respectively, as illustrated by and described with reference to FIG. 3. For example, the first mapping rule may be a subband centric mapping rule and the second mapping rule may be a non-subband centric mapping rule (e.g., a rule that combines coefficients of multiple subbands).

In some examples, such as example in which the mapping rule 410-a includes the first mapping rule, the part 406-a may indicate a mapping (e.g., a single mapping) for the coefficients. That is, one or more fields included in the part 406-a may indicate the mapping for the coefficients (e.g., may be associated with both the first downlink subband and the second downlink subband). In some other examples, such as example in which the mapping rule 410-a includes the second mapping rule, the part 406-a may indicate a first mapping for a first portion of the coefficients and a second mapping for a second portion of the coefficients. In some examples, the first portion of the coefficients may correspond to the first downlink subband and the second portion of the coefficients may correspond to the second downlink subband.

In the example of FIG. 4A, the part 405-a may include one or more fields associated with (e.g., common to) the first downlink subband and the second downlink subband. For example, the part 405-a may include an RI 415-a, which may be a field that indicates an RI associated with (e.g., common to) the first downlink subband and the second downlink subband. Additionally, the part 405-a may include a CQI 416-a, which may be a field that indicates a CQI associated with (e.g., common to) the first downlink subband and the second downlink subband. In some examples, the part 405-a may include a number of non-zero coefficients (NNSC) field. That is, the part 405-a may include an NNZC 417-a which may indicate a quantity (e.g., a total quantity, a total number) of non-zero coefficients across one or more layers (e.g., all layers associated with one or both of the first downlink subband and the second downlink subband).

In some examples, the part 406-a may include one or more fields associated with the first downlink subband and the second downlink subband. For example, the part 406-a may include a spatial basis selection 420-a (e.g., a spatial domain beam selection), which may indicate a subset of spatial domain bases (e.g., L spatial beams) selected from a set of spatial domain bases (e.g., a set of spatial beams). In some examples, the spatial basis selection 420-a may include a beam group indication and a beam indication. In such examples, for each beam, the UE may perform codebook subset restriction to an average power across multiple (e.g., all) coefficients of each polarization. Additionally, in such examples, multiple beam groups (e.g., up to about 4 beam groups) may be restricted, in which each beam of each group may restricted by a quantity (Yᵢ), which may be indicated to the UE via an RRC configuration (e.g., a via 2-bit RRC configuration). In some examples, the spatial basis selection 420-a may be common to the first downlink subband and the second downlink subband. That is, the spatial domain basis set indicated via the spatial basis selection 420-a may be associated with the first downlink subband and the second downlink subband. Additionally, the part 406-a may include a frequency basis selection 421-a, which may indicate a first subset of frequency domain bases selected (e.g., for each layer) from a first set of frequency domain bases (e.g., N₃ frequency domain bases) for compression of the first portion of coefficients and indicate a second subset of frequency domain bases selected (e.g., for each layer) from a second set of frequency domain bases (e.g., N₃ frequency domain bases) for compression of the second portion of coefficients. In some examples, the part 406-a may include an SCI 422-a, which may indicate a first location of a strongest coefficient among the first portion of coefficients and a second location of a strongest coefficient among the second portion of coefficients. Additionally, the part 406-a may include a coefficient selection 423-a, which may indicate a respective location of each coefficient of the first portion of coefficients and a respective location of each coefficient of the second portion of coefficients. In some examples, the respective location of each coefficient of the first portion of coefficients and the respective location of each coefficient of the second portion of coefficients may depend on (e.g., be determined in accordance with) the mapping rule 410-a.

In some examples, the UE may quantize the non-zero coefficients (e.g., may use layer-independent quantization) in accordance with one or more steps. For example, in a first step the UE may identify a strongest coefficient (e.g., the strongest coefficient among the first portion of coefficients or the strongest coefficient among the second set of coefficients). In such an example, the UE may report an index of the strongest coefficient (e.g., using the SCI 422-a). In some examples, the strongest coefficient may have a value of 1 and, accordingly, the UE may refrain from quantizing the strongest coefficient. Additionally, or alternatively, the UE may use the strongest coefficient as a first reference for a first polarization (e.g., a relatively stronger polarization among two polarizations). In a second step, the UE may identify a second reference for a second polarization (e.g., a relatively weaker polarization among the two polarizations). In some examples, the UE may quantize the second reference. In a third step, the UE may perform an amplitude quantization (e.g., differential amplitude quantization) and in a fourth step the UE may perform a phase quantization. Accordingly, in some examples, the part 406-a may include a coefficient quantization 424-a, which may indicate a first amplitude quantization for the first downlink subband (e.g., performed in the third step for the first downlink subband), a first phase quantization for the first downlink subband (e.g., performed in the fourth step for the first downlink subband), a second amplitude quantization for the second downlink subband (e.g., performed in the third step for the second downlink subband), or a second phase quantization for the second downlink subband (e.g., performed in the fourth step for the second downlink subband), or any combination thereof.

As illustrated in the example of FIG. 4B, the payload structure 400-b may be such that the report includes three parts. For example, in accordance with the payload structure 400-b, the report may include a part 405-b (e.g., UCI part 1), a part 406-b (e.g., UCI part 2), and a part 407 (e.g., UCI part 3). In some examples, based on the report including three parts (e.g., the part 405-b, the part 406-b, the part 407), the UE may use a mapping rule 410-b to generate the report. In such an example, the part 405-b may be associated with (e.g., common to) the first downlink subband and the second downlink subband, part 406-b may be associated with (e.g., for) the first downlink subband, and the part 407 may be associated with (e.g., for) the second downlink subband. In some examples, based on the payload structure 400-b including three parts, the mapping rule 410-b may include a third mapping rule (e.g., a subband centric mapping rule illustrated by and described with reference to FIG. 3). For example, in accordance with the mapping rule 410-b, the part 406-b may indicate the first mapping for the first portion of the coefficients (e.g., the portion of the coefficients corresponding to the first downlink subband) and the part 407 may indicate the second mapping for the second portion of the coefficients (e.g., the portion of the coefficients corresponding to the second downlink subband). In some examples, the part 406-b may indicate a spatial domain basis common to the first downlink subband and the second downlink subband.

In the example of FIG. 4B, the part 405-b may include one or more fields associated with (e.g., common to) the first downlink subband and the second downlink subband. For example, the part 405-b may include an RI 415-b, which may be a field that indicates the RI associated with (e.g., common to) the first downlink subband and the second downlink subband. Additionally, the part 405-b may include a CQI 416-b, which may be a field that indicates the CQI associated with (e.g., common to) the first downlink subband and the second downlink subband. In some examples, the part 405-b may include an NNZC 417-b which may indicate the quantity (e.g., a total quantity, a total number) of non-zero coefficients across one or more layers (e.g., all layers associated with one or both of the first downlink subband and the second downlink subband).

In some examples, the part 406-b may include one or more fields associated with the first downlink subband and at least a field associated with the first downlink subband and the second downlink subband. For example, the part 406-b may include a spatial basis selection 420-b (e.g., a spatial domain beam selection), which may indicate the subset of spatial domain bases (e.g., L spatial beams) selected from the set of spatial domain bases (e.g., the set of spatial beams). In some examples, the spatial basis selection 420-b may include the beam group indication and the beam indication. In some examples, the spatial basis selection 420-b may be common to the first downlink subband and the second downlink subband. That is, the spatial domain basis set indicated via the spatial basis selection 420-b may be associated with the first downlink subband and the second downlink subband. Additionally, the part 406-b may include a frequency basis selection 421-b, which may indicate the first subset of frequency domain bases selected (e.g., for each layer) from the first set of frequency domain bases (e.g., N₃ frequency domain bases) for compression of the first portion of coefficients. In some examples, the part 406-b may include an SCI 422-b, which may indicate the first location of a strongest coefficient among the first portion of coefficients. Additionally, the part 406-b may include a coefficient selection 423-b, which may indicate the respective location of each coefficient of the first portion of coefficients. In some examples, the respective location of each coefficient of the first portion of coefficients may depend on (e.g., be determined in accordance with) the mapping rule 410-b. Additionally, the part 406-b may include a coefficient quantization 424-b, which may indicate the first amplitude quantization for the first downlink subband or the first phase quantization for the first downlink subband, or both.

In some examples, the part 407 may include one or more fields associated with the second downlink subband. For example, the part 407 may include a frequency basis selection 421-c, which may indicate the second subset of frequency domain bases selected (e.g., for each layer) from the second set of frequency domain bases (e.g., N₃ frequency domain bases) for compression of the second portion of coefficients. In some examples, the part 407 may include an SCI 422-c, which may indicate the second location of the strongest coefficient among the second portion of coefficients. Additionally, the part 407 may include a coefficient selection 423-c, which may indicate the respective location of each coefficient of the second portion of coefficients. In some examples, the respective location of each coefficient of the second portion of coefficients may depend on (e.g., be determined in accordance with) the mapping rule 410-b. Additionally, the part 407 may include a coefficient quantization 424-c, which may indicate a indicate the first amplitude quantization for the second downlink subband or the first phase quantization for the second downlink subband, or both.

In some examples, UCI part 1 (the part 405-a and the part 405-b) may include a field (e.g., the NNZC 417-a and the NNZC 417-b) that indicates a quantity of non-zero coefficients

$$( {K}_{NZ}^{tot} )$$

per subband included in the PMI reporting (e.g., included in the one or more mappings). In some instances, the contents of the field (e.g., the interpretation of the contents of the field) may depend on the quantity of reporting subband (N₃) and the eType-II parameter combination (e.g., the choice of (L, p₁, p₃, β)). For example, the quantity of non-zero coefficients may depend on the non-zero coefficients for each layer (e.g., K₀ in which K₀=[β×2LM₁]) and the quantity of frequency domain bases for each layer (e.g., M₁ in which

$${M}_{1} = ⌈ {p}_{1} \times \frac{{N}_{3}}{R} ⌉ ) .$$

In other words, the field that indicates the quantity of coefficients included in the report (e.g., the NNZC 417-a and the NNZC 417-b) may be based on a quantity of reporting subbands associated with the first downlink subband and the second downlink subband or the set of parameters indicated via the report configuration, or both.

In some examples, the NNZC 417-a and the NNZC 417-b may indicate a same quantity of non-zero coefficients for the first downlink subband and the second downlink subband. For example, the field (e.g., the NNZC 417-a or the NNZC 417-b) may indicate a same quantity of coefficients for each of the first downlink subband and the second downlink subband. In such an example, the quantity of non-zero coefficients

$$( {K}_{N Z}^{tot} )$$

may be indicated per downlink subband, such that the quantity of non-zero coefficients over two downlink subbands (e.g., for the first downlink subband and the second downlink subband) may be equal to

$$2 {K}_{N Z}^{tot} .$$

In some other examples, the quantity of non-zero coefficients

$$( {K}_{N Z}^{tot} )$$

may be indicated over multiple downlink subband, such that the quantity of non-zero coefficients per downlink subbands (e.g., for the first downlink subband or the second downlink subband) may be equal to

$${K}_{N Z}^{tot} / 2.$$

In such examples, the report configuration (e.g., used at the UE for generating the report) may indicate a same set of parameters (e.g., a same eType-II parameter combination), a same quantity of PMI subbands (e.g., a same quantity of CSI subbands), and a same value of M₁ for the first downlink subband and the second downlink subband. That is, the set of parameters indicated to the UE via the report configuration may include a same set of parameters for each of the first downlink subband and the second downlink subband.

In some other examples, the NNZC 417-a and the NNZC 417-b may indicate a respective (e.g., different) quantity of non-zero coefficients for the first downlink subband and the second downlink subband. That is, the quantity of non-zero coefficients may be different for the first downlink subband and the second downlink subband. In such an example, the NNZC 417-a and the NNZC 417-b may each include a first subfield (e.g., NNZC_{SB1}) to indicate the quantity of non-zero coefficients for the first downlink subband and a second subfield (e.g., NNZC_{SB2}) to indicate the quantity of non-zero coefficients for the second downlink subband. In other words, the field (e.g., the NNZC 417-a and the NNZC 417-b) may indicate a first portion of the quantity of coefficients that corresponds to a first downlink subband and a second portion of the quantity of coefficients that corresponds to the second downlink subband. In such examples, the first downlink subband and the second downlink subband may each be associated with a respective quantity of reporting subbands (e.g., CSI subbands) or a same set of reporting subbands. Additionally, in such examples, the first downlink subband and the second downlink subband may each be associated with a same set of parameters or a respective set of parameters. In some examples, the quantity of non-zero coefficients

$$( {K}_{N Z}^{tot} )$$

may be indicated as NNZC_{SB1}+NNZC_{SB2}. For example, the report (e.g., the CSI report) may include the first subfield (e.g., NNZC_{SB1}) or the second subfield (e.g., NNZC_{SB2}), or both, in part 406-b or part 407. That is, the part 406-b may include the first subfield or both the first subfield and the second subfield and the part 407 may include the second subfield or both the first subfield and the second subfield. In some examples, using a mapping rule that is based on the payload structure may lead to improved CSI reporting, among other possible benefits.

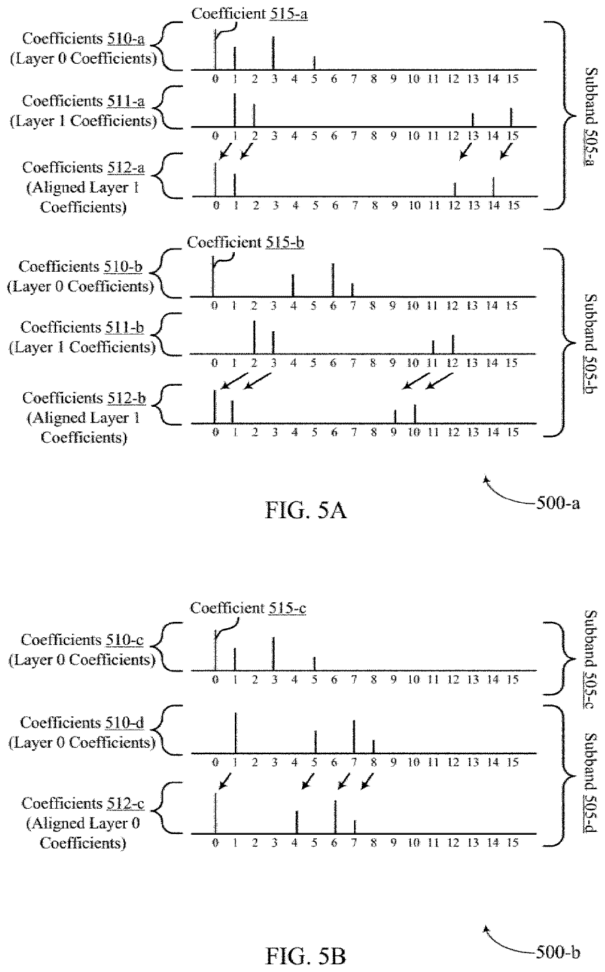

FIGS. 5A and 5B illustrate examples of coefficient alignment schemes 500 that support parameter reporting for multiple subbands in accordance with one or more aspects of the present disclosure. The coefficient alignment schemes 500 (e.g., a coefficient alignment scheme 500-a and a coefficient alignment scheme 500-b) may implement or be implemented at one or more aspects of the wireless communications system 100, the wireless communications system 200, the coefficient mapping scheme 300, and the payload structures 400. For example, the coefficient alignment schemes 500 may be implemented at a UE or a network entity, which may be examples of the corresponding devices illustrated by and described with reference to FIGS. 1 through 3, 4A, and 4B.

In some examples, a quantity of reporting subbands (e.g., N₃ CSI subbands) may fail to satisfy a threshold (e.g., N₃<19). In such examples, the UE may perform an alignment of coefficients associated with multiple downlink subbands. For example, the UE may align a strongest coefficient (e.g., corresponding to the coefficient indicated via an SCI) at a frequency domain basis with an index of 0 (e.g., frequency domain basis 0). That is, each layer (e.g., of each subband 505) may be associated with one or more coefficients that may each correspond to a respective frequency domain basis (e.g., of a set of frequency domain bases indexed from 0 to 15). In some examples, the strongest coefficient used for alignment (e.g., the coefficient indicated via the SCI field included in the report) may be common (e.g., to multiple downlink subbands) or per-downlink subband.

As illustrated in the example of FIG. 5A, the UE may align each downlink subband (e.g., a subband 505-a and a subband 505-b) in accordance with a respective strongest coefficient (e.g., separately). That is, the UE may align the strongest coefficient of each layer (e.g., of each downlink subband) at the frequency domain basis 0, which may be different for each downlink subband (e.g., for the subband 505-a and the subband 505-b). For example, coefficients 510-a (e.g., Layer 0 coefficients) of the subband 505-a may include a coefficient 515-a, which may correspond to the strongest coefficient among the coefficients 510-a. In such an example, the UE may align the strongest coefficient of each layer associated with the subband 505-a based on (e.g., with respect to, in accordance with) the coefficient 515-a. For example, the UE may shift coefficients 511-a (e.g., Layer 1 coefficients) of the subband 505-a, such that coefficients 512-a (e.g., aligned Layer 1 coefficients) of the subband 505-a, which may be reported to the network entity (e.g., after the alignment), may have a same index remapping as the Layer 0 coefficients 510-a. In other words, the UE may align a first portion of coefficients (e.g., the Layer 0 coefficients 510-a and the Layer 1 coefficients 511-a) that corresponds to a first downlink subband (e.g., the subband 505-a) in accordance with a first coefficient included in the first portion (e.g., the coefficient 515-a). Additionally, coefficients 510-b (e.g., Layer 0 coefficients) of the subband 505-b may include a coefficient 515-b, which may correspond to the strongest coefficient among the Layer 0 coefficients 510-b. In such an example, the UE may align the strongest coefficient of each layer associated with the subband 505-b based on (e.g., with respect to, in accordance with) the coefficient 515-b. For example, the UE may shift (e.g., adjust, move) coefficients 511-b (e.g., Layer 1 coefficients) of the subband 505-b, such that the coefficients 512-b (e.g., aligned Layer 1 coefficients) of the subband 505-b, which may be reported to the network entity (e.g., after the alignment), may have a same index remapping as the Layer 0 coefficients 510-b. In other words, the UE may align a second portion of the coefficients (e.g., the Layer 0 coefficients 510-b and the Layer 1 coefficients 511-b) that correspond to a second downlink subband (e.g., the subband 505-b) in accordance with a second coefficient (e.g., the coefficient 515-b).

As illustrated in the example of FIG. 5B, the UE may align the strongest coefficient of each layer of a subband 505-c and a subband 505-d at frequency domain basis 0 of the subband 505-c. For example, coefficients 510-c (e.g., Layer 0 coefficients) of the subband 505-c may include a coefficient 515-c, which may correspond to the strongest coefficient among the coefficients 510-c. In such an example, the UE may align the strongest coefficient of each layer associated with the subband 505-d in accordance with the coefficient 515-c. That is, the UE may apply a same index remapping to one or more layers (e.g., Layer 0, Layer 1, Layer 2, . . . ,) associated with the subband 505-c and one or more layers (e.g., Layer 0, Layer 1, Layer 2, . . . ,) associated with the subband 505-d. In other words, the UE may shift coefficients 510-d (e.g., Layer 0 coefficients) of the subband 505-d, such that coefficients 512-c (e.g., aligned Layer 0 coefficients) of the subband 505-d, which may be reported to the network entity (e.g., after the alignment), may have a same index remapping as the coefficients 510-c. That is, the UE may align a first portion of coefficients (e.g., the coefficients 510-c) that corresponds to a first downlink subband (e.g., the subband 505-c) based on (e.g., with respect to, in accordance with) a first coefficient included in the first portion (e.g., the coefficient 515-c) and a second portion of the coefficients (e.g., the coefficients 510-d) that correspond to a second downlink subband (e.g., the subband 505-c) based on (e.g., with respect to, in accordance with) the first coefficient (e.g., the coefficient 515-c). In such an example, the UE may report (e.g., signal) a spatial domain basis index of the strongest coefficient (e.g., for each layer) via a quantity of bits (e.g., log₂ 2L bits).

In some examples, for a layer (i), the UE may denote the frequency domain basis index of the strongest coefficient prior to index remapping as

$${k}_{{m}_{i}}^{*}$$

(e.g.,

$${k}_{{m}_{i}}^{*}$$

may not be reported). Additionally, in some examples, the UE may remap the frequency domain baswis with the respect to

$${k}_{{m}_{i}}^{*}$$

as \tilde{k}ₘ_{ᵢ}, such that

$${\tilde{k}}_{{m}_{i}}^{*} = 0$$

(e.g.,

$${\tilde{k}}_{{m}_{i}} = mod ( {k}_{{m}_{i}} - {k}_{{m}_{i}}^{*} , {N}_{3} ) ) .$$

In such examples, the UE may report \tilde{k}ₘ_{ᵢ} for i=0, 1, . . . M−1. In some examples, aligning the coefficients in accordance with a common SCI or per-downlink subband SCI may lead to increased CSI reporting, among other possible benefits.

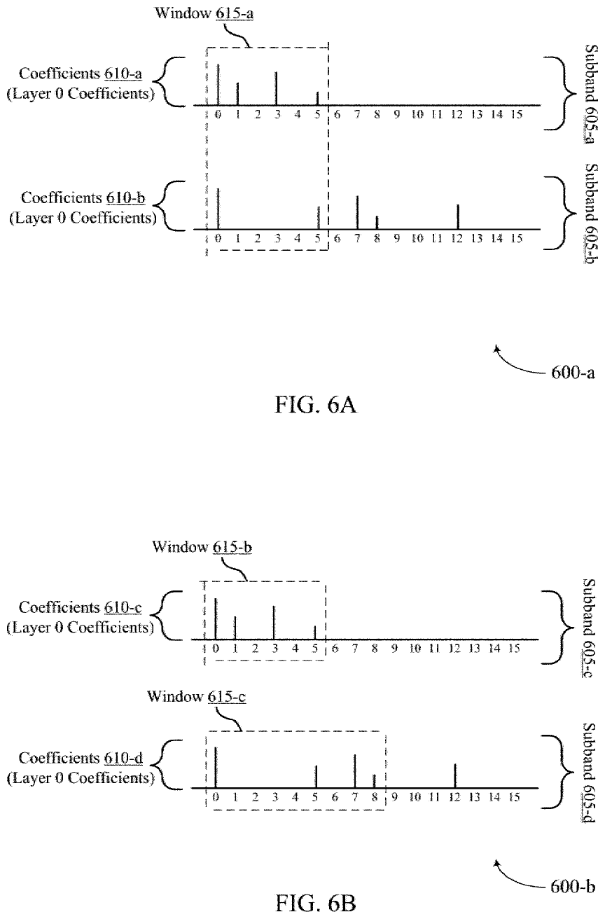

FIGS. 6A and 6B illustrate example of basis selection schemes 600 that support parameter reporting for multiple subbands in accordance with one or more aspects of the present disclosure. The basis selection schemes 600 (e.g., a basis selection scheme 600-a and a basis selection scheme 600-b) may implement or be implemented at one or more aspects of the wireless communications system 100, the wireless communications system 200, the coefficient mapping scheme 300, the payload structures 400, and the coefficient alignment schemes 500. For example, the basis selection schemes 600 may be implemented at a UE or a network entity, which may be examples of the corresponding devices illustrated by and described with reference to FIGS. 1 through 3, 4A, 4B, 5A, and 5B.

In some examples, a quantity of reporting subbands (e.g., N₃ CSI subbands) may satisfy a threshold (e.g., N₃>19). In such examples, the UE may perform a two-stage frequency domain report procedure (e.g., subsequent to the UE performing a coefficient alignment in accordance with one of the coefficient alignment schemes 500 as described in accordance with FIGS. 5A and 5B). For example, in a first stage, the UE may down-select a window-based intermediate set of frequency domain bases (e.g., that each correspond to a respective coefficient) from a frequency domain basis set (e.g., the set of N₃ frequency domain bases). Additionally, in a second stage, the UE may report the subset of frequency domain bases (e.g., and the corresponding coefficients) for each layer. That is, the UE may select coefficients in accordance with the basis selection scheme 600-a or the basis selection scheme 600-b. In other words, the UE may use a window-based intermediate set of coefficients obtained via down selection.

In the example of FIG. 6A, the UE may determine that a quantity of reporting subbands associated with a subband 605-a and a subband 605-b satisfies the threshold. In such an example, the UE may select a first set of coefficients from coefficients 610-a (e.g., Layer 0 coefficients of the subband 605-a) and a second set of coefficients from coefficients 610-b (e.g., Layer 0 coefficients of the subband 605-b) based on the determination. As illustrated in the example of FIG. 6A, the UE may use a common window (e.g., a window 615-a) to select the first set of coefficients (e.g., and the corresponding frequency domain bases) for the subband 605-a and to select the second set of coefficients (e.g., and the corresponding frequency domain bases) for the subband 605-b. In some examples, the window 615-a may include frequency domain bases 0 through 5. In such examples, the first set of coefficients may include coefficients (e.g., any coefficients) within the coefficients 610-a that correspond to the frequency domain bases 0 through 5. Additionally, in such examples, the second set of coefficients may include coefficients (e.g., any coefficients) within the coefficients 610-b that correspond to the frequency domain bases 0 through 5. In such an example, the UE may report (e.g., to the network entity) the window 615-a for the subband 605-a.

In the example of FIG. 6B, the UE may determine that a quantity of reporting subbands associated with a subband 605-c and a subband 605-d satisfies the threshold. In such an example, the UE may select a first set of coefficients (e.g., and the corresponding frequency domain bases) from coefficients 610-c (e.g., Layer 0 coefficients associated with the subband 605-c) and a second set of coefficients (e.g., and the corresponding frequency domain bases) from coefficients 610-d (e.g., Layer 0 coefficients associated with the subband 605-d) based on the determination. As illustrated in the example of FIG. 6B, the UE may use multiple (e.g., different) windows to select the first set of coefficients for the subband 605-c and to select the second set of coefficients for the subband 605-d. For example, the UE may use a window 615-b to select the first set of coefficients for the subband 605-c and a window 615-c to select the second set of coefficients for the subband 605-d. In some examples, the window 615-b may include frequency domain bases 0 through 5. In such examples, the first set of coefficients may include coefficients (e.g., any coefficients) within the coefficients 610-c that correspond to the frequency domain bases 0 through 5. Additionally, in some examples, the window 615-c may include frequency domain bases 0 through 8. In such examples, the second set of coefficients may include coefficients (e.g., any coefficients) within the coefficients 610-d that correspond to the frequency domain bases 0 through 8. In such an example, the UE may report the window 615-b for the subband 605-c and the window 615-c for the subband 605-c. In some examples, selecting the coefficients in accordance with a common window or per-downlink subband windows may lead to improved CSI reporting, among other possible benefits.

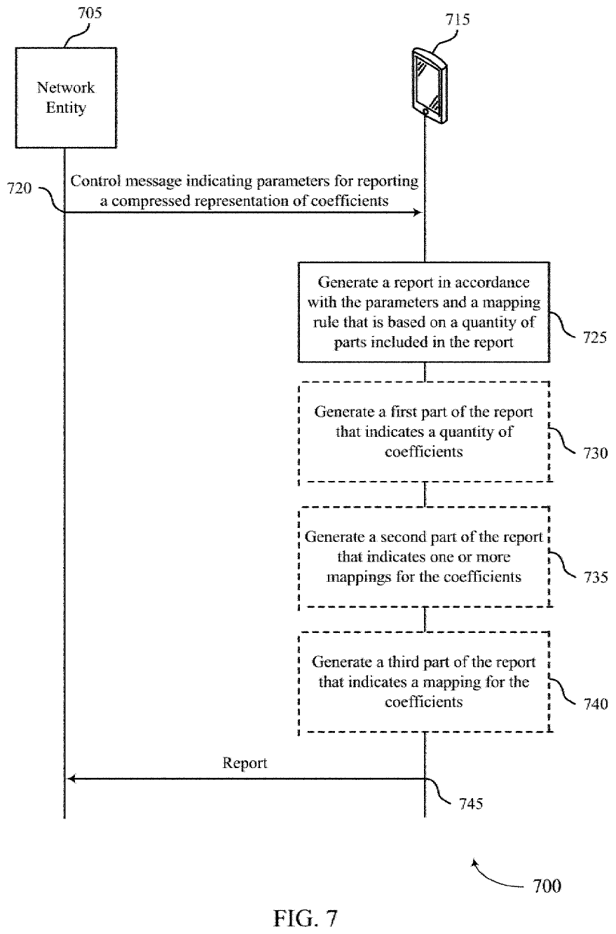

FIG. 7 illustrates an example of a process flow 700 that supports parameter reporting for multiple subbands in accordance with one or more aspects of the present disclosure. The process flow 700 may implement or be implemented at one or more aspects of the wireless communications system 100, the wireless communications system 200, the coefficient mapping scheme 300, the payload structures 400, the coefficient alignment schemes 500, and the basis selection schemes 600. For example, the process flow 700 may be implemented at a UE 715 and a network entity 705, which may be examples of the corresponding devices illustrated by and described with reference to FIGS. 1 through 3, 4A, 4B, 5A, 5B, 6A, and 6B. The operations performed at the UE 715 and the network entity 705 may support improvements to communications between the UE 715 and the network entity 705, among other benefits. In the following description of the process flow 700, the operations performed at the UE 715 and the network entity 705 may occur in a different order than the example order shown. Additionally, the operations performed at the UE 715 and the network entity 705 may be performed at different times. Some operations may be combined and some operations may be omitted. In some examples, the UE 715 and the network entity 705 may support a framework for reporting precoding matrix coefficients for multiple subbands in a single report.

At 720, the UE 715 may receive a control message indicating a set of parameters for compressed reporting (e.g., indicating parameters for reporting a compressed representation of coefficients). In some examples, the control message may be an example of a report configuration as described throughout the present disclosure, including with reference to FIGS. 1-3, 4A, 4B, 5A, 5B, 6A, and 6B. For example, the set of parameters may include a same set of parameters for each subband of multiple downlink subbands associated with SBFD operations. In some other examples, the set of parameters includes a respective subset of parameters for each subband of the multiple downlink subbands. In some examples, the coefficients may correspond to the multiple downlink subbands associated with SBFD operations. For example, the coefficients may correspond to a first downlink subband and a second downlink subband that may be non-contiguous in frequency.

At 725, the UE 715 may generate a report (e.g., that indicates the compressed representation of the coefficients) in accordance with the parameters and a mapping rule that is based on a quantity of parts included in the report. In some examples, the report may be an example of a report as described throughout the present disclosure, including with reference to FIGS. 1-3, 4A, 4B, 5A, 5B, 6A, and 6B. For example, the report may include a first part (e.g., UCI part 1) and at least a second part (e.g., UCI part 2 or UCI part 2 and UCI part 3), in which at least the second part indicates one or more mappings that are based on the mapping rule. In such an example, the first part and at least the second part may indicate the compressed representation of the coefficients.

In some examples, at 730, the UE 715 may generate the first part of the report that indicates a quantity of coefficients. For example, the first part of the report may be an example of UCI part 1 as described throughout the present disclosure, including with reference to FIGS. 4A and 4B. In such an example, the first part may indicate a quantity of coefficients included in a first portion of the coefficients (e.g., a first set of coefficients) associated with the first downlink subband and a quantity of coefficients included in a second portion of the coefficients (e.g., a second set of coefficients) associated with the second downlink subband.

In some examples, at 735, the UE 715 may generate the second part of the report that indicates one or more mappings for the coefficients (e.g., the first set of coefficients and the second set of coefficients). The second part of the report may be an example of UCI part 2 as described throughout the present disclosure, including with reference to FIGS. 4A and 4B. For example, the second part may indicate a first mapping for the first set of coefficients and a second mapping for the second set of coefficients. In such an example, the mapping rule may correspond to a first mapping rule (e.g., a subband centric mapping rule) as described throughout the present disclosure, including with reference to FIG. 4A. In some other examples, the second part may indicate a mapping (e.g., a single mapping) for the first set of coefficients and the second set of coefficients that may be based on the mapping rule. In such examples, the mapping rule may correspond to a second mapping rule (e.g., a non-subband centric mapping rule, a rule for combining coefficients of multiple subbands) as described throughout the present disclosure, including with reference to FIG. 4A.

In some examples, the second part of the report may indicate the first mapping for the first set of coefficients and a third part of the report may indicate the second mapping for the second set of coefficients. For example, at 740, the UE 715 may generate the third part of the report that indicates a mapping for the coefficients. In some examples, the third part may be an example of UCI part 3 as described throughout the present disclosure, including with reference to FIG. 4B. For example, the third part may indicate the second mapping for the second set of coefficients. Additionally, in such an example, the mapping rule may correspond to a mapping rule (e.g., a subband centric mapping rule) as described throughout the present disclosure, including with reference to FIG. 4B.

At 745, the UE 715 may transmit the report to the network entity 705 based on the generation. In some examples, the report may be an example of a report as described throughout the present disclosure, including with reference to FIGS. 1-3, 4A, 4B, 5A, 5B, 6A, and 6B. For example, the report may be a CSI report (e.g., a CSF report) based on CSI measurements performed at the UE 715 using CSI-RS transmitted from the network entity 705. In some examples, generating the report in accordance with the mapping rule and the set of parameters may provide one or more enhancements to CSI reporting, among other possible benefits.

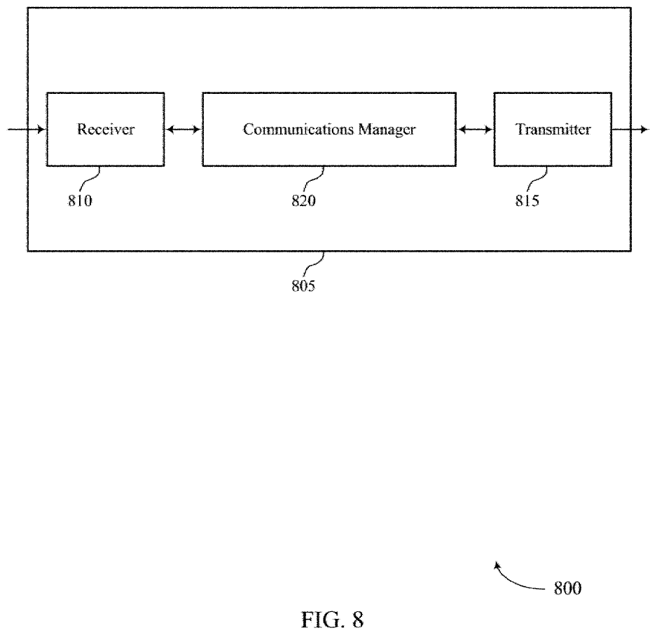

FIG. 8 illustrates a block diagram 800 of a device 805 that supports parameter reporting for multiple subbands in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to parameter reporting for multiple subbands). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to parameter reporting for multiple subbands). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of parameter reporting for multiple subbands as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE (e.g., the device 805) in accordance with examples as disclosed herein. For example, the communications manager 820 may be configured as or otherwise support a means for receiving a control message that indicates a set of parameters for reporting a compressed representation of a set of multiple coefficients for a precoding matrix, the set of multiple coefficients corresponding to a set of multiple downlink subbands associated with SBFD operations. The communications manager 820 may be configured as or otherwise support a means for generating a report that indicates the compressed representation of the set of multiple coefficients, where the report is generated in accordance with the set of parameters and a mapping rule that is based on a quantity of parts included in the report. The communications manager 820 may be configured as or otherwise support a means for transmitting the report based on the generation.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for more efficient utilization of communication resources.

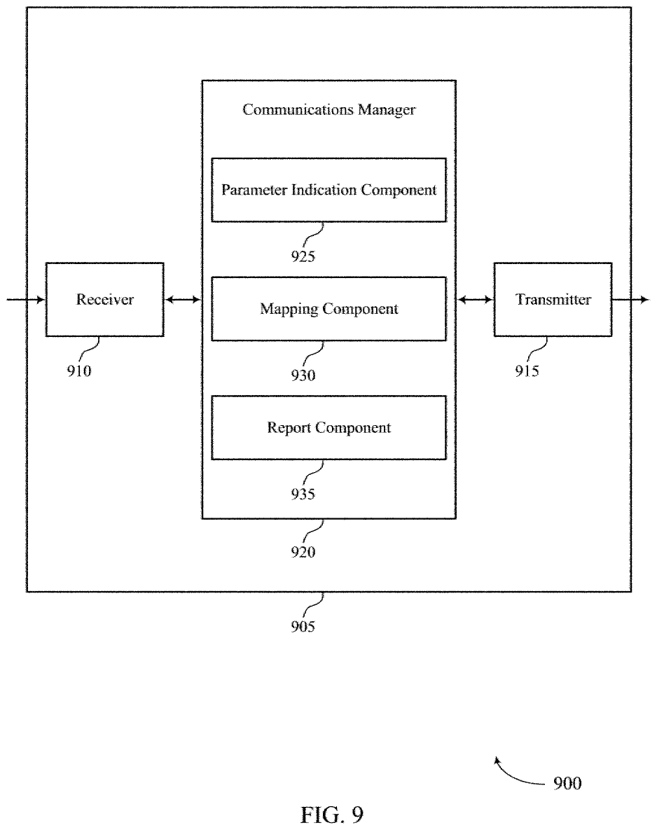

FIG. 9 illustrates a block diagram 900 of a device 905 that supports parameter reporting for multiple subbands in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to parameter reporting for multiple subbands). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to parameter reporting for multiple subbands). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of parameter reporting for multiple subbands as described herein. For example, the communications manager 920 may include a parameter indication component 925, a mapping component 930, a report component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE (e.g., the device 905) in accordance with examples as disclosed herein. The parameter indication component 925 may be configured as or otherwise support a means for receiving a control message that indicates a set of parameters for reporting a compressed representation of a set of multiple coefficients for a precoding matrix, the set of multiple coefficients corresponding to a set of multiple downlink subbands associated with SBFD operations. The mapping component 930 may be configured as or otherwise support a means for generating a report that indicates the compressed representation of the set of multiple coefficients, where the report is generated in accordance with the set of parameters and a mapping rule that is based on a quantity of parts included in the report. The report component 935 may be configured as or otherwise support a means for transmitting the report based on the generation.

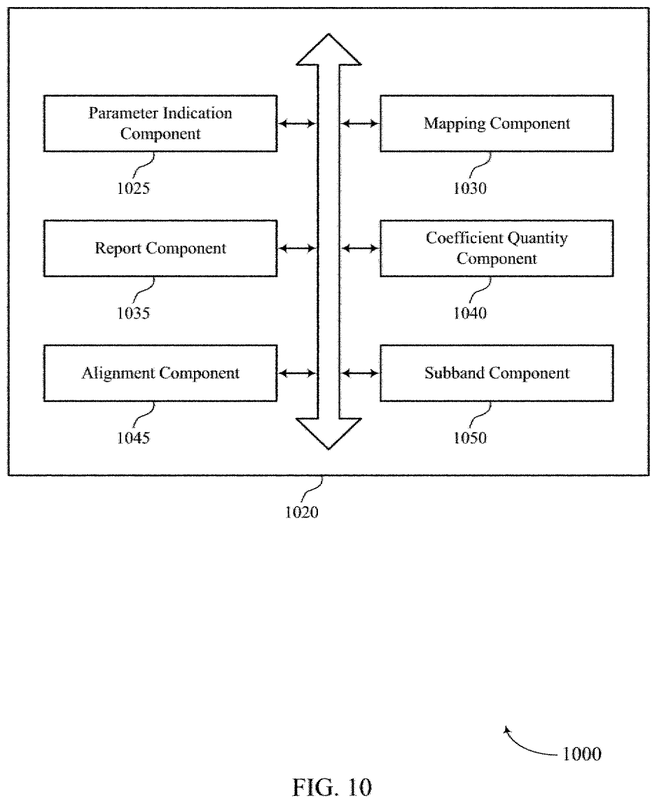

FIG. 10 illustrates a block diagram 1000 of a communications manager 1020 that supports parameter reporting for multiple subbands in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of parameter reporting for multiple subbands as described herein. For example, the communications manager 1020 may include a parameter indication component 1025, a mapping component 1030, a report component 1035, a coefficient quantity component 1040, an alignment component 1045, a subband component 1050, or any combination thereof. Each of these components may communicate, directly or indirectly, with one another (e.g., via one or more buses).

The communications manager 1020 may support wireless communication at a UE in accordance with examples as disclosed herein. The parameter indication component 1025 may be configured as or otherwise support a means for receiving a control message that indicates a set of parameters for reporting a compressed representation of a set of multiple coefficients for a precoding matrix, the set of multiple coefficients corresponding to a set of multiple downlink subbands associated with SBFD operations. The mapping component 1030 may be configured as or otherwise support a means for generating a report that indicates the compressed representation of the set of multiple coefficients, where the report is generated in accordance with the set of parameters and a mapping rule that is based on a quantity of parts included in the report. The report component 1035 may be configured as or otherwise support a means for transmitting the report based on the generation.

In some examples, to support generating the report, the coefficient quantity component 1040 may be configured as or otherwise support a means for generating a first part of the report that indicates a quantity of coefficients included in the set of multiple coefficients. In some examples, to support generating the report, the mapping component 1030 may be configured as or otherwise support a means for generating at least a second part of the report that indicates one or more mappings for the set of multiple coefficients, where the one or more mappings are based on the mapping rule, and where the first part and at least the second part indicate the compressed representation of the set of multiple coefficients.

In some examples, to support generating at least the second part of the report, the mapping component 1030 may be configured as or otherwise support a means for generating the second part that indicates a first mapping for a first portion of the set of multiple coefficients and a second mapping for a second portion of the set of multiple coefficients, where the first portion corresponds to a first downlink subband of the set of multiple downlink subbands, and where the second portion corresponds to a second downlink subband of the set of multiple downlink subbands.

In some examples, to support generating at least the second part of the report, the mapping component 1030 may be configured as or otherwise support a means for generating the second part that indicates a mapping for the set of multiple coefficients, where the mapping is based on the mapping rule.

In some examples, to support generating at least the second part of the report, the mapping component 1030 may be configured as or otherwise support a means for generating the second part that indicates a first mapping for a first portion of the set of multiple coefficients, the first portion corresponding to a first downlink subband of the set of multiple downlink subbands. In some examples, to support generating at least the second part of the report, the mapping component 1030 may be configured as or otherwise support a means for generating a third part that indicates a second mapping for a second portion of the set of multiple coefficients, the second portion corresponding to a second downlink subband of the set of multiple downlink subbands.

In some examples, the second part further indicates a spatial domain basis set associated with the first downlink subband and the second downlink subband. In some examples, the set of parameters includes a same set of parameters for each subband of the set of multiple downlink subbands. In some examples, the set of parameters includes a respective subset of parameters for each subband of the set of multiple downlink subbands.

In some examples, the report includes a field that indicates a quantity of coefficients included in the set of multiple coefficients. In some examples, the field is based on a quantity of reporting subbands associated with the set of multiple downlink subbands or the set of parameters, or both.

In some examples, each downlink subband of the set of multiple downlink subbands is associated with a same quantity of reporting subbands or a same set of parameters, or both. In some examples, the field indicates a same quantity of coefficients for each downlink subband of the set of multiple downlink subbands.

In some examples, each downlink subband of the set of multiple downlink subbands is associated with a respective quantity of reporting subbands or a respective set of parameters, or both. In some examples, the field indicates a first portion of the quantity of coefficients that corresponds to a first downlink subband of the set of multiple downlink subbands and indicates a second portion of the quantity of coefficients that corresponds to a second downlink subband of the set of multiple downlink subbands.

In some examples, the alignment component 1045 may be configured as or otherwise support a means for aligning a first portion of the set of multiple coefficients that corresponds to a first downlink subband of the set of multiple downlink subbands in accordance with a first coefficient included in the first portion. In some examples, the alignment component 1045 may be configured as or otherwise support a means for aligning a second portion of the set of multiple coefficients that correspond to a second downlink subband in accordance with the first coefficient or a second coefficient included in the second portion, where the compressed representation of the set of multiple coefficients is based on the alignment of the first portion and the second portion.

In some examples, the subband component 1050 may be configured as or otherwise support a means for determining that a quantity of reporting subbands associated with the set of multiple downlink subbands satisfies a threshold. In some examples, the coefficient quantity component 1040 may be configured as or otherwise support a means for selecting a first set of coefficients from the first portion and a second set of coefficients from the second portion based on the determination, where the compressed representation of the set of multiple coefficients is based on the first set of coefficients and the second set of coefficients.

In some examples, the first set of coefficients and the second set of coefficients are selected in accordance with a same selection window. In some examples, the first set of coefficients is selected in accordance with a first selection window associated with the first downlink subband and the second set of coefficients is selected in accordance with a second selection window associated with the second downlink subband. In some examples, the first selection window is different from the second selection window.

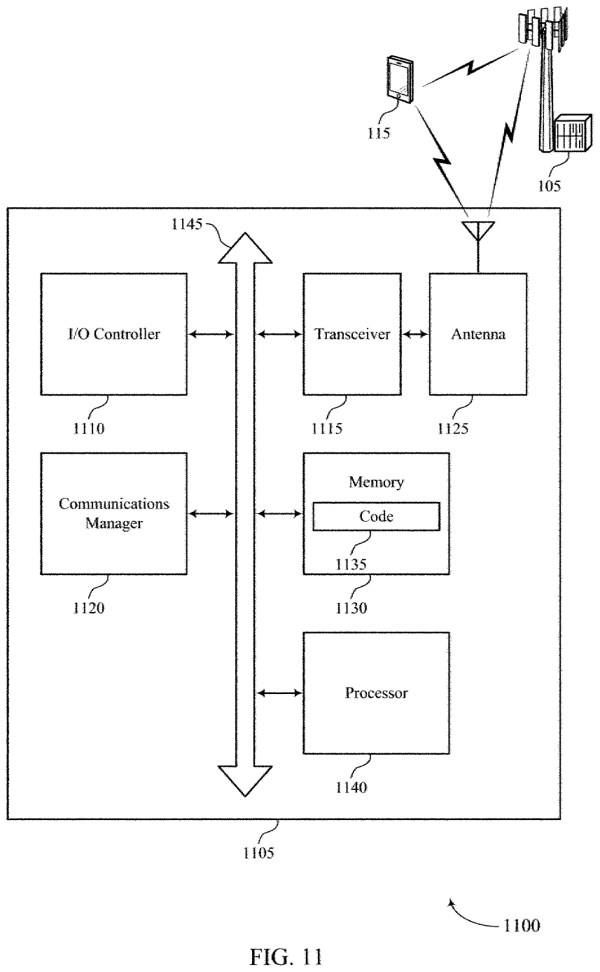

FIG. 11 illustrates a diagram of a system 1100 including a device 1105 that supports parameter reporting for multiple subbands in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting parameter reporting for multiple subbands). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE (e.g., the device 1105) in accordance with examples as disclosed herein. For example, the communications manager 1120 may be configured as or otherwise support a means for receiving a control message that indicates a set of parameters for reporting a compressed representation of a set of multiple coefficients for a precoding matrix, the set of multiple coefficients corresponding to a set of multiple downlink subbands associated with SBFD operations. The communications manager 1120 may be configured as or otherwise support a means for generating a report that indicates the compressed representation of the set of multiple coefficients, where the report is generated in accordance with the set of parameters and a mapping rule that is based on a quantity of parts included in the report. The communications manager 1120 may be configured as or otherwise support a means for transmitting the report based on the generation.

By including or configuring the communications manager 1120 in accordance with examples as described herein, the device 1105 may support techniques for improved communication reliability, reduced latency, and more efficient utilization of communication resources.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of parameter reporting for multiple subbands as described herein, or the processor 1140 and the memory 1130 may be otherwise configured to perform or support such operations.

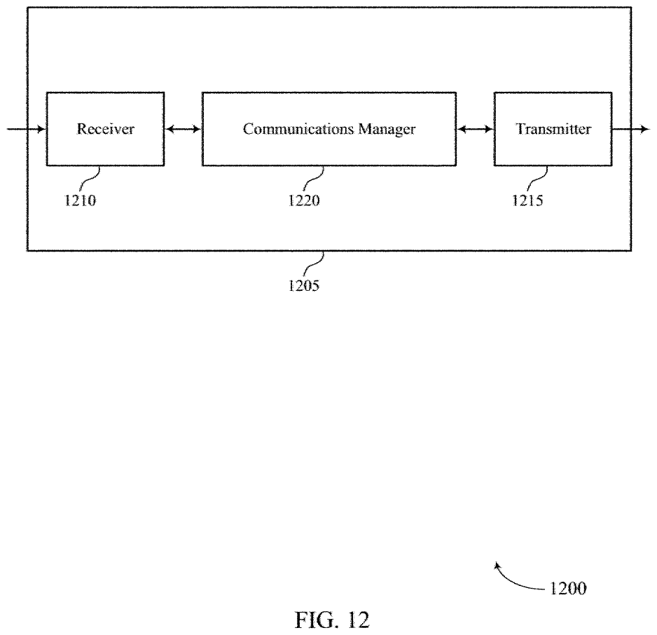

FIG. 12 illustrates a block diagram 1200 of a device 1205 that supports parameter reporting for multiple subbands in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of parameter reporting for multiple subbands as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity (e.g., the device 1205) in accordance with examples as disclosed herein. For example, the communications manager 1220 may be configured as or otherwise support a means for outputting a control message that indicates a set of parameters for reporting a compressed representation of a set of multiple coefficients for a precoding matrix, the set of multiple coefficients corresponding to a set of multiple downlink subbands associated with SBFD operations. The communications manager 1220 may be configured as or otherwise support a means for obtaining a report that indicates the compressed representation of the set of multiple coefficients in response to outputting the control message, where the report is generated in accordance with the set of parameters and a mapping rule that is based on a quantity of parts included in the report.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for more efficient utilization of communication resources.

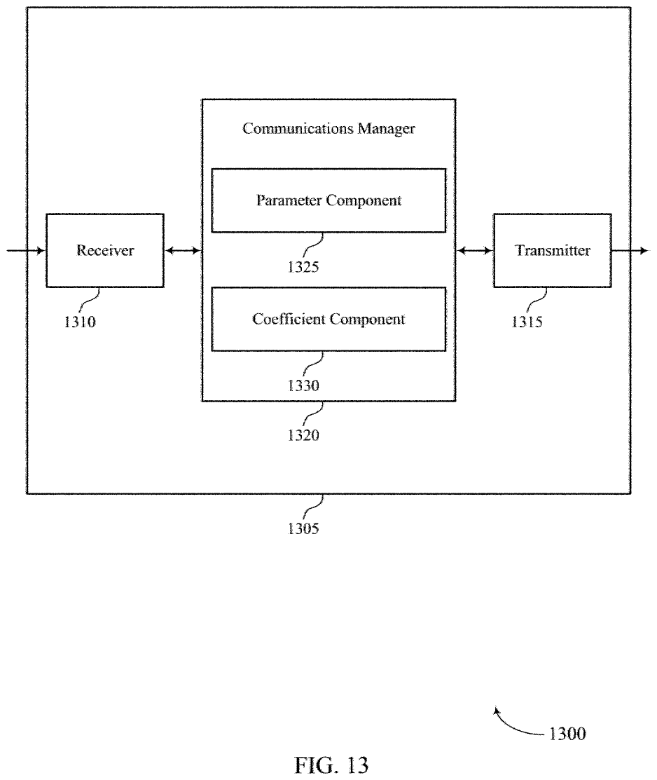

FIG. 13 illustrates a block diagram 1300 of a device 1305 that supports parameter reporting for multiple subbands in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of parameter reporting for multiple subbands as described herein. For example, the communications manager 1320 may include a parameter component 1325 a coefficient component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity (e.g., the device 1305) in accordance with examples as disclosed herein. The parameter component 1325 may be configured as or otherwise support a means for outputting a control message that indicates a set of parameters for reporting a compressed representation of a set of multiple coefficients for a precoding matrix, the set of multiple coefficients corresponding to a set of multiple downlink subbands associated with SBFD operations. The coefficient component 1330 may be configured as or otherwise support a means for obtaining a report that indicates the compressed representation of the set of multiple coefficients in response to outputting the control message, where the report is generated in accordance with the set of parameters and a mapping rule that is based on a quantity of parts included in the report.

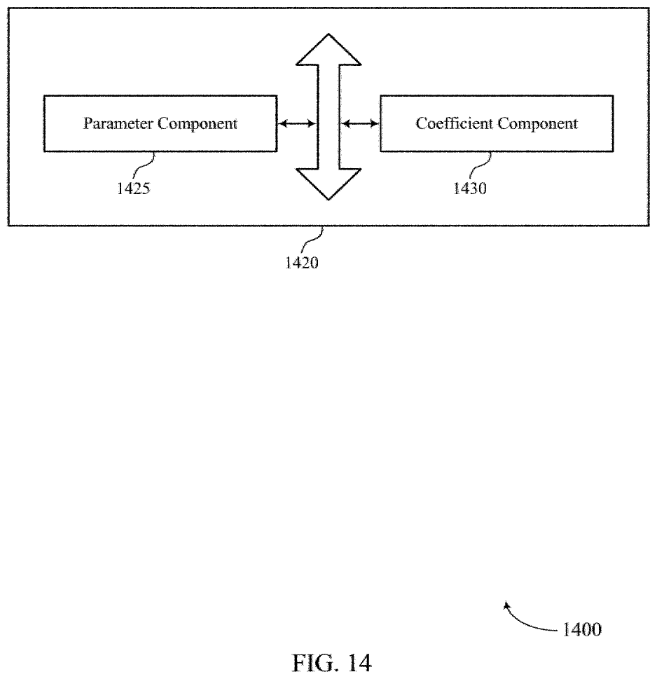

FIG. 14 illustrates a block diagram 1400 of a communications manager 1420 that supports parameter reporting for multiple subbands in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of parameter reporting for multiple subbands as described herein. For example, the communications manager 1420 may include a parameter component 1425, a coefficient component 1430, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The parameter component 1425 may be configured as or otherwise support a means for outputting a control message that indicates a set of parameters for reporting a compressed representation of a set of multiple coefficients for a precoding matrix, the set of multiple coefficients corresponding to a set of multiple downlink subbands associated with SBFD operations. The coefficient component 1430 may be configured as or otherwise support a means for obtaining a report that indicates the compressed representation of the set of multiple coefficients in response to outputting the control message, where the report is generated in accordance with the set of parameters and a mapping rule that is based on a quantity of parts included in the report.

In some examples, the report includes a first part that indicates a quantity of coefficients included in the set of multiple coefficients and at least a second part that indicates one or more mappings for the set of multiple coefficients. In some examples, the one or more mappings are based on the mapping rule. In some examples, the first part and at least the second part indicate the compressed representation of the set of multiple coefficients.

In some examples, the second part of the report indicates a first mapping for a first portion of the set of multiple coefficients and a second mapping for a second portion of the set of multiple coefficients. In some examples, the first portion correspond to a first downlink subband of the set of multiple downlink subbands. In some examples, the second portion corresponds to a second downlink subband of the set of multiple downlink subbands. In some examples, the second part of the report indicates a mapping for the set of multiple coefficients. In some examples, the mapping is based on the mapping rule.

In some examples, the second part of the report indicates a first mapping for a first portion of the set of multiple coefficients and a third part of the report indicates a second mapping for a second portion of the set of multiple coefficients. In some examples, the first portion corresponds to a first downlink subband of the set of multiple downlink subbands. In some examples, the second portion corresponds to a second downlink subband of the set of multiple downlink subbands.

In some examples, the set of parameters includes a same set of parameters for each subband of the set of multiple downlink subbands. In some examples, the set of parameters includes a respective subset of parameters for each subband of the set of multiple downlink subbands. In some examples, the report includes a field that indicates a quantity of coefficients included in the set of multiple coefficients. In some examples, the field is based on a quantity of reporting subbands associated with the set of multiple downlink subbands or the set of parameters, or both.

In some examples, a first portion of the set of multiple coefficients that corresponds to a first downlink subband of the set of multiple downlink subbands is aligned in accordance with a first coefficient of the set of multiple coefficients and a second portion of the set of multiple coefficients that correspond to a second downlink subband is aligned in accordance with the first coefficient or a second coefficient of the set of multiple coefficients. In some examples, the compressed representation of the set of multiple coefficients is based on the alignment of the first portion and the second portion.

In some examples, a quantity of reporting subbands associated with the set of multiple downlink subbands satisfies a threshold. In some examples, the compressed representation of the set of multiple coefficients is based on a first set of coefficients selected from the first portion and a second set of coefficients selected from the second portion, the first set of coefficients and the second set of coefficients are based on the quantity of subbands satisfying the threshold.

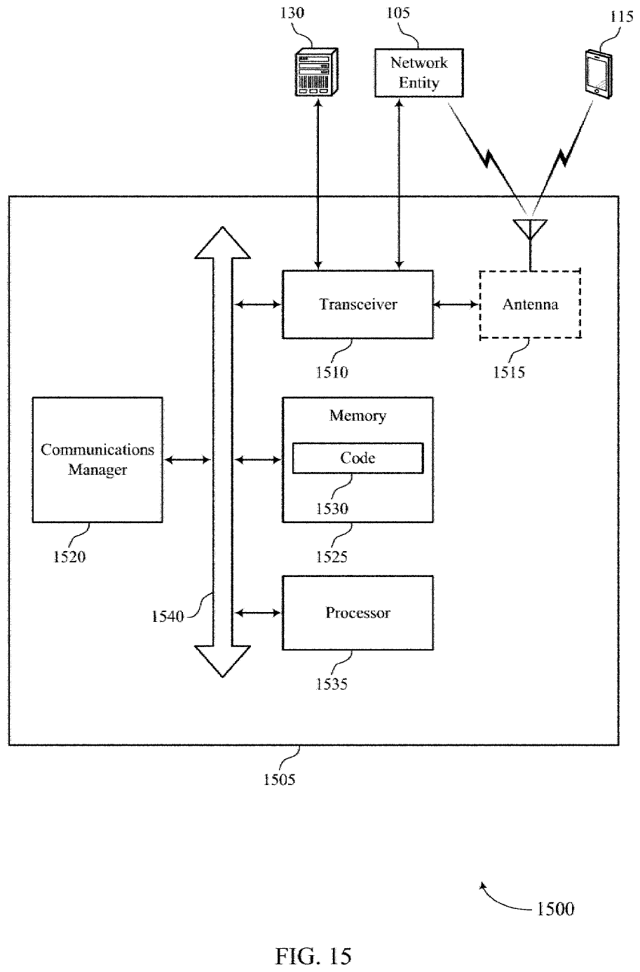

FIG. 15 illustrates a diagram of a system 1500 including a device 1505 that supports parameter reporting for multiple subbands in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting parameter reporting for multiple subbands). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity (e.g., the device 1505) in accordance with examples as disclosed herein. For example, the communications manager 1520 may be configured as or otherwise support a means for outputting a control message that indicates a set of parameters for reporting a compressed representation of a set of multiple coefficients for a precoding matrix, the set of multiple coefficients corresponding to a set of multiple downlink subbands associated with SBFD operations. The communications manager 1520 may be configured as or otherwise support a means for obtaining a report that indicates the compressed representation of the set of multiple coefficients in response to outputting the control message, where the report is generated in accordance with the set of parameters and a mapping rule that is based on a quantity of parts included in the report.

By including or configuring the communications manager 1520 in accordance with examples as described herein, the device 1505 may support techniques for improved communication reliability, reduced latency, and more efficient utilization of communication resources.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of parameter reporting for multiple subbands as described herein, or the processor 1535 and the memory 1525 may be otherwise configured to perform or support such operations.

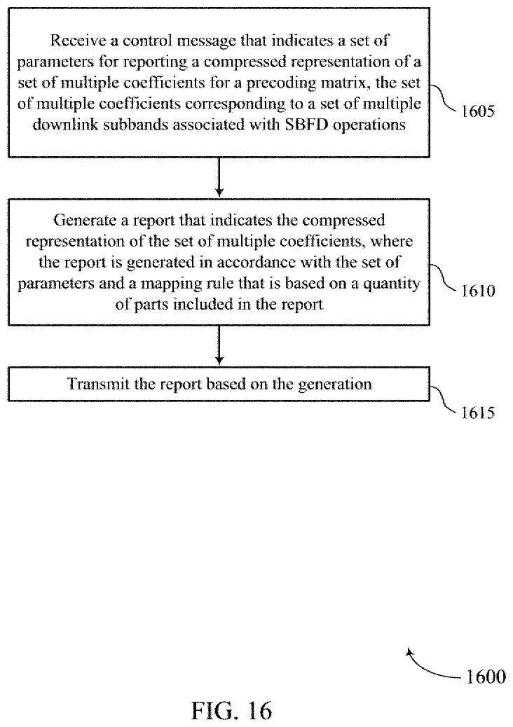

FIG. 16 illustrates a flowchart showing a method 1600 that supports parameter reporting for multiple subbands in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving a control message that indicates a set of parameters for reporting a compressed representation of a set of multiple coefficients for a precoding matrix, the set of multiple coefficients corresponding to a set of multiple downlink subbands associated with SBFD operations. The operations of 1605 may be performed in accordance with examples as disclosed herein. In some examples, aspects of the operations of 1605 may be performed by a parameter indication component 1025 as described with reference to FIG. 10.

At 1610, the method may include generating a report that indicates the compressed representation of the set of multiple coefficients, where the report is generated in accordance with the set of parameters and a mapping rule that is based on a quantity of parts included in the report. The operations of 1610 may be performed in accordance with examples as disclosed herein. In some examples, aspects of the operations of 1610 may be performed by a mapping component 1030 as described with reference to FIG. 10.

At 1615, the method may include transmitting the report based on the generation. The operations of 1615 may be performed in accordance with examples as disclosed herein. In some examples, aspects of the operations of 1615 may be performed by a report component 1035 as described with reference to FIG. 10.

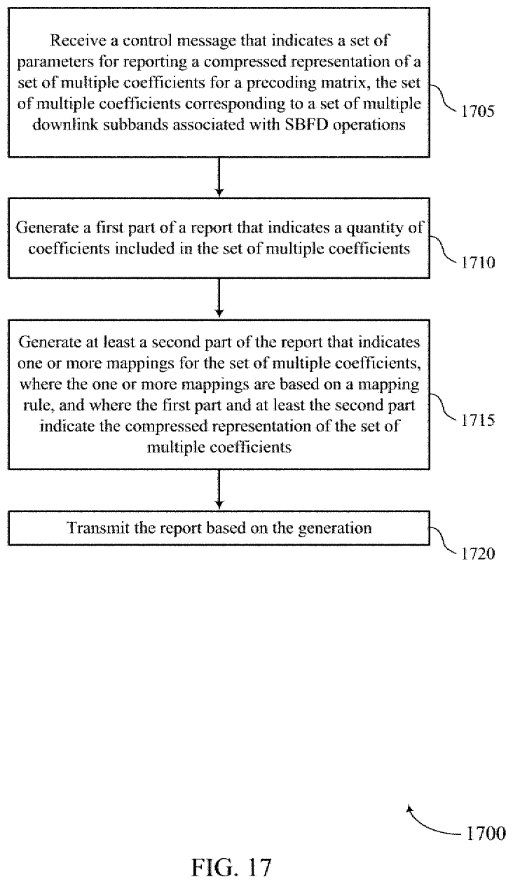

FIG. 17 illustrates a flowchart showing a method 1700 that supports parameter reporting for multiple subbands in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving a control message that indicates a set of parameters for reporting a compressed representation of a set of multiple coefficients for a precoding matrix, the set of multiple coefficients corresponding to a set of multiple downlink subbands associated with SBFD operations. The operations of 1705 may be performed in accordance with examples as disclosed herein. In some examples, aspects of the operations of 1705 may be performed by a parameter indication component 1025 as described with reference to FIG. 10.

At 1710, the method may include generating a first part of a report that indicates a quantity of coefficients included in the set of multiple coefficients. The operations of 1710 may be performed in accordance with examples as disclosed herein. In some examples, aspects of the operations of 1710 may be performed by a coefficient quantity component 1040 as described with reference to FIG. 10.

At 1715, the method may include generating at least a second part of the report that indicates one or more mappings for the set of multiple coefficients, where the one or more mappings are based on a mapping rule, and where the first part and at least the second part indicate the compressed representation of the set of multiple coefficients. The operations of 1715 may be performed in accordance with examples as disclosed herein. In some examples, aspects of the operations of 1715 may be performed by a mapping component 1030 as described with reference to FIG. 10.

At 1720, the method may include transmitting the report based on the generation. The operations of 1720 may be performed in accordance with examples as disclosed herein. In some examples, aspects of the operations of 1720 may be performed by a report component 1035 as described with reference to FIG. 10.

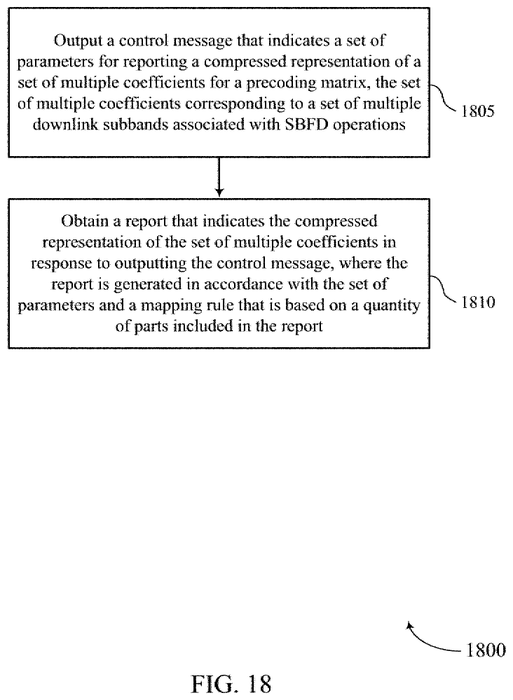

FIG. 18 illustrates a flowchart showing a method 1800 that supports parameter reporting for multiple subbands in accordance with one or more aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include outputting a control message that indicates a set of parameters for reporting a compressed representation of a set of multiple coefficients for a precoding matrix, the set of multiple coefficients corresponding to a set of multiple downlink subbands associated with SBFD operations. The operations of 1805 may be performed in accordance with examples as disclosed herein. In some examples, aspects of the operations of 1805 may be performed by a parameter component 1425 as described with reference to FIG. 14.

At 1810, the method may include obtaining a report that indicates the compressed representation of the set of multiple coefficients in response to outputting the control message, where the report is generated in accordance with the set of parameters and a mapping rule that is based on a quantity of parts included in the report. The operations of 1810 may be performed in accordance with examples as disclosed herein. In some examples, aspects of the operations of 1810 may be performed by a coefficient component 1430 as described with reference to FIG. 14.

The following provides an overview of aspects of the present disclosure:
Aspect 1: A method for wireless communication at a UE, comprising: receiving a control message that indicates a set of parameters for reporting a compressed representation of a plurality of coefficients for a precoding matrix, the plurality of coefficients corresponding to a plurality of downlink subbands associated with SBFD operations; generating a report that indicates the compressed representation of the plurality of coefficients, wherein the report is generated in accordance with the set of parameters and a mapping rule that is based at least in part on a quantity of parts included in the report; and transmitting the report based at least in part on the generation.
Aspect 2: The method of aspect 1, wherein the report comprises at least two parts, and wherein generating the report comprises: generating a first part of the report that indicates a quantity of coefficients included in the plurality of coefficients; and generating at least a second part of the report that indicates one or more mappings for the plurality of coefficients, wherein the one or more mappings are based at least in part on the mapping rule, and wherein the first part and at least the second part indicate the compressed representation of the plurality of coefficients.
Aspect 3: The method of aspect 2, wherein generating at least the second part of the report comprises: generating the second part that indicates a first mapping for a first portion of the plurality of coefficients and a second mapping for a second portion of the plurality of coefficients, wherein the first portion corresponds to a first downlink subband of the plurality of downlink subbands, and wherein the second portion corresponds to a second downlink subband of the plurality of downlink subbands.
Aspect 4: The method of aspect 2, wherein generating at least the second part of the report comprises: generating the second part that indicates a mapping for the plurality of coefficients, wherein the mapping is based at least in part on the mapping rule.
Aspect 5: The method of aspect 2, wherein generating at least the second part of the report comprises: generating the second part that indicates a first mapping for a first portion of the plurality of coefficients, the first portion corresponding to a first downlink subband of the plurality of downlink subbands; and generating a third part that indicates a second mapping for a second portion of the plurality of coefficients, the second portion corresponding to a second downlink subband of the plurality of downlink subbands.
Aspect 6: The method of aspect 5, wherein the second part further indicates a spatial domain basis set associated with the first downlink subband and the second downlink subband.
Aspect 7: The method of any of aspects 1 through 6, wherein the set of parameters includes a same set of parameters for each subband of the plurality of downlink subbands.
Aspect 8: The method of any of aspects 1 through 6, wherein the set of parameters includes a respective subset of parameters for each subband of the plurality of downlink subbands.
Aspect 9: The method of any of aspects 1 through 8, wherein the report includes a field that indicates a quantity of coefficients included in the plurality of coefficients, and the field is based at least in part on a quantity of reporting subbands associated with the plurality of downlink subbands or the set of parameters, or both.
Aspect 10: The method of aspect 9, wherein each downlink subband of the plurality of downlink subbands is associated with a same quantity of reporting subbands or a same set of parameters, or both, and the field indicates a same quantity of coefficients for each downlink subband of the plurality of downlink subbands.
Aspect 11: The method of aspect 9, wherein each downlink subband of the plurality of downlink subbands is associated with a respective quantity of reporting subbands or a respective set of parameters, or both, and the field indicates a first portion of the quantity of coefficients that corresponds to a first downlink subband of the plurality of downlink subbands and indicates a second portion of the quantity of coefficients that corresponds to a second downlink subband of the plurality of downlink subbands.
Aspect 12: The method of any of aspects 1 through 11, further comprising: aligning a first portion of the plurality of coefficients that corresponds to a first downlink subband of the plurality of downlink subbands in accordance with a first coefficient included in the first portion; and aligning a second portion of the plurality of coefficients that correspond to a second downlink subband in accordance with the first coefficient or a second coefficient included in the second portion, wherein the compressed representation of the plurality of coefficients is based at least in part on the alignment of the first portion and the second portion.
Aspect 13: The method of aspect 12, further comprising: determining that a quantity of reporting subbands associated with the plurality of downlink subbands satisfies a threshold; and selecting a first set of coefficients from the first portion and a second set of coefficients from the second portion based at least in part on the determination, wherein the compressed representation of the plurality of coefficients is based at least in part on the first set of coefficients and the second set of coefficients.
Aspect 14: The method of aspect 13, wherein the first set of coefficients and the second set of coefficients are selected in accordance with a same selection window.
Aspect 15: The method of aspect 13, wherein the first set of coefficients is selected in accordance with a first selection window associated with the first downlink subband and the second set of coefficients is selected in accordance with a second selection window associated with the second downlink subband, the first selection window being different from the second selection window.
Aspect 16: A method for wireless communication at a network entity, comprising: outputting a control message that indicates a set of parameters for reporting a compressed representation of a plurality of coefficients for a precoding matrix, the plurality of coefficients corresponding to a plurality of downlink subbands associated with SBFD operations; and obtaining a report that indicates the compressed representation of the plurality of coefficients in response to outputting the control message, wherein the report is generated in accordance with the set of parameters and a mapping rule that is based at least in part on a quantity of parts included in the report.
Aspect 17: The method of aspect 16, wherein the report comprises a first part that indicates a quantity of coefficients included in the plurality of coefficients and at least a second part that indicates one or more mappings for the plurality of coefficients, the one or more mappings are based at least in part on the mapping rule, and the first part and at least the second part indicate the compressed representation of the plurality of coefficients.
Aspect 18: The method of aspect 17, wherein the second part of the report indicates a first mapping for a first portion of the plurality of coefficients and a second mapping for a second portion of the plurality of coefficients, the first portion correspond to a first downlink subband of the plurality of downlink subbands, and the second portion corresponds to a second downlink subband of the plurality of downlink subbands.
Aspect 19: The method of aspect 17, wherein the second part of the report indicates a mapping for the plurality of coefficients, and the mapping is based at least in part on the mapping rule.
Aspect 20: The method of aspect 17, wherein the second part of the report indicates a first mapping for a first portion of the plurality of coefficients and a third part of the report indicates a second mapping for a second portion of the plurality of coefficients, the first portion corresponds to a first downlink subband of the plurality of downlink subbands, and the second portion corresponds to a second downlink subband of the plurality of downlink subbands.
Aspect 21: The method of any of aspects 16 through 20, wherein the set of parameters includes a same set of parameters for each subband of the plurality of downlink subbands.
Aspect 22: The method of any of aspects 16 through 20, wherein the set of parameters includes a respective subset of parameters for each subband of the plurality of downlink subbands.
Aspect 23: The method of any of aspects 16 through 22, wherein the report includes a field that indicates a quantity of coefficients included in the plurality of coefficients, and the field is based at least in part on a quantity of reporting subbands associated with the plurality of downlink subbands or the set of parameters, or both.
Aspect 24: The method of any of aspects 16 through 23, wherein a first portion of the plurality of coefficients that corresponds to a first downlink subband of the plurality of downlink subbands is aligned in accordance with a first coefficient of the plurality of coefficients and a second portion of the plurality of coefficients that correspond to a second downlink subband is aligned in accordance with the first coefficient or a second coefficient of the plurality of coefficients, and the compressed representation of the plurality of coefficients is based at least in part on the alignment of the first portion and the second portion.
Aspect 25: The method of aspect 24, wherein a quantity of reporting subbands associated with the plurality of downlink subbands satisfies a threshold, and the compressed representation of the plurality of coefficients is based at least in part on a first set of coefficients selected from the first portion and a second set of coefficients selected from the second portion, the first set of coefficients and the second set of coefficients are based at least in part on the quantity of subbands satisfying the threshold.
Aspect 26: An apparatus for wireless communication, comprising a processor; memory in electronic communication with the processor; and instructions stored in the memory and executable by the processor to perform a method of any of aspects 1 through 15.
Aspect 27: An apparatus for wireless communication, comprising at least one means for performing a method of any of aspects 1 through 15.
Aspect 28: A non-transitory computer-readable medium storing code for wireless communication at a UE, the code comprising instructions executable to perform a method of any of aspects 1 through 15.
Aspect 29: An apparatus for wireless communication, comprising a processor; memory in electronic communication with the processor; and instructions stored in the memory and executable by the processor to perform a method of any of aspects 16 through 25.
Aspect 30: An apparatus for wireless communication, comprising at least one means for performing a method of any of aspects 16 through 25.
Aspect 31: A non-transitory computer-readable medium storing code for wireless communication at a network entity, the code comprising instructions executable to perform a method of any of aspects 16 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
a processor;
memory in electronic communication with the processor; and
instructions stored in the memory, wherein the instructions are executable by the processor to:
receive a control message that indicates a set of parameters for reporting a compressed representation of a plurality of coefficients for a precoding matrix, the plurality of coefficients corresponding to a plurality of downlink subbands associated with subband full-duplex operations;
generate a report that indicates the compressed representation of the plurality of coefficients, wherein the report is generated in accordance with the set of parameters and a mapping rule that is based at least in part on a quantity of parts included in the report; and transmit the report based at least in part on the generation.

2. The apparatus of claim 1, wherein the instructions executable by the processor to generate the report comprise instructions executable by the processor to:
generate a first part of the report that indicates a quantity of coefficients included in the plurality of coefficients; and
generate at least a second part of the report that indicates one or more mappings for the plurality of coefficients, wherein the one or more mappings are based at least in part on the mapping rule, and wherein the first part and at least the second part indicate the compressed representation of the plurality of coefficients.

3. The apparatus of claim 2, wherein the instructions executable by the processor to generate at least the second part of the report comprise instructions executable by the processor to:
generate the second part that indicates a first mapping for a first portion of the plurality of coefficients and a second mapping for a second portion of the plurality of coefficients, wherein the first portion corresponds to a first downlink subband of the plurality of downlink subbands, and wherein the second portion corresponds to a second downlink subband of the plurality of downlink subbands.

4. The apparatus of claim 2, wherein the instructions executable by the processor to generate at least the second part of the report comprise instructions executable by the processor to:
generate the second part that indicates a mapping for the plurality of coefficients, wherein the mapping is based at least in part on the mapping rule.

5. The apparatus of claim 2, wherein the instructions executable by the processor to generate at least the second part of the report comprise instructions executable by the processor to:
generate the second part that indicates a first mapping for a first portion of the plurality of coefficients, the first portion corresponding to a first downlink subband of the plurality of downlink subbands; and
generate a third part that indicates a second mapping for a second portion of the plurality of coefficients, the second portion corresponding to a second downlink subband of the plurality of downlink subbands.

6. The apparatus of claim 5, wherein the second part further indicates a spatial domain basis set associated with the first downlink subband and the second downlink subband.

7. The apparatus of claim 1, wherein the set of parameters includes a same set of parameters for each subband of the plurality of downlink subbands.

8. The apparatus of claim 1, wherein the set of parameters includes a respective subset of parameters for each subband of the plurality of downlink subbands.

9. The apparatus of claim 1, wherein the report includes a field that indicates a quantity of coefficients included in the plurality of coefficients, and wherein the field is based at least in part on a quantity of reporting subbands associated with the plurality of downlink subbands or the set of parameters, or both.

10. The apparatus of claim 9, wherein each downlink subband of the plurality of downlink subbands is associated with a same quantity of reporting subbands or a same set of parameters, or both, and wherein the field indicates a same quantity of coefficients for each downlink subband of the plurality of downlink subbands.

11. The apparatus of claim 9, wherein each downlink subband of the plurality of downlink subbands is associated with a respective quantity of reporting subbands or a respective set of parameters, or both, and wherein the field indicates a first portion of the quantity of coefficients that corresponds to a first downlink subband of the plurality of downlink subbands and indicates a second portion of the quantity of coefficients that corresponds to a second downlink subband of the plurality of downlink subbands.

12. The apparatus of claim 1, wherein the instructions are further executable by the processor to:
align a first portion of the plurality of coefficients that corresponds to a first downlink subband of the plurality of downlink subbands in accordance with a first coefficient included in the first portion; and
align a second portion of the plurality of coefficients that correspond to a second downlink subband in accordance with the first coefficient or a second coefficient included in the second portion, wherein the compressed representation of the plurality of coefficients is based at least in part on the alignment of the first portion and the second portion.

13. The apparatus of claim 12, wherein the instructions are further executable by the processor to:
determine that a quantity of reporting subbands associated with the plurality of downlink subbands satisfies a threshold; and
select a first set of coefficients from the first portion and a second set of coefficients from the second portion based at least in part on the determination, wherein the compressed representation of the plurality of coefficients is based at least in part on the first set of coefficients and the second set of coefficients.

14. The apparatus of claim 13, wherein the first set of coefficients and the second set of coefficients are selected in accordance with a same selection window.

15. The apparatus of claim 13, wherein the first set of coefficients is selected in accordance with a first selection window associated with the first downlink subband and the second set of coefficients is selected in accordance with a second selection window associated with the second downlink subband, the first selection window being different from the second selection window.

16. An apparatus for wireless communication, comprising:
a processor;
memory in electronic communication with the processor; and
instructions stored in the memory, wherein the instructions are executable by the processor to:
output a control message that indicates a set of parameters for reporting a compressed representation of a plurality of coefficients for a precoding matrix, the plurality of coefficients corresponding to a plurality of downlink subbands associated with subband full-duplex operations; and
obtain a report that indicates the compressed representation of the plurality of coefficients in response to outputting the control message, wherein the report is generated in accordance with the set of parameters and a mapping rule that is based at least in part on a quantity of parts included in the report.

17. The apparatus of claim 16, wherein the report comprises a first part that indicates a quantity of coefficients included in the plurality of coefficients and at least a second part that indicates one or more mappings for the plurality of coefficients, wherein the one or more mappings are based at least in part on the mapping rule, and wherein the first part and at least the second part indicate the compressed representation of the plurality of coefficients.

18. The apparatus of claim 17, wherein the second part of the report indicates a first mapping for a first portion of the plurality of coefficients and a second mapping for a second portion of the plurality of coefficients, wherein the first portioncorrespond to a first downlink subband of the plurality of downlink subbands, and wherein the second portion corresponds to a second downlink subband of the plurality of downlink subbands.

19. The apparatus of claim 17, wherein the second part of the report indicates a mapping for the plurality of coefficients, and wherein the mapping is based at least in part on the mapping rule.

20-25. (canceled)

26. A method for wireless communication at a user equipment (UE), comprising:
receiving a control message that indicates a set of parameters for reporting a compressed representation of a plurality of coefficients for a precoding matrix, the plurality of coefficients corresponding to a plurality of downlink subbands associated with subband full-duplex operations;
generating a report that indicates the compressed representation of the plurality of coefficients, wherein the report is generated in accordance with the set of parameters and a mapping rule that is based at least in part on a quantity of parts included in the report; and
transmitting the report based at least in part on the generation.

27-30. (canceled)
